(19) United States
(12) Patent Application Publication
(10) Pub. No.: US 2012/0184635 A1
(43) Pub. Date: Jul. 19, 2012

(54) Flameproof expandable polymerizates

(75) Inventors: Roman Eberstaller, Obergrafendorf (AT); Gerhard Hintermeier, St. Poelten (AT)

(73) Assignee: Sunpor Kunststoff Ges m.b.H., St. Poelten (AT)

(21) Appl. No.: 13/381,880

(22) PCT Filed: Jul. 5, 2010
(86) PCT No.: PCT/AT10/00246

§ 371 Date: Mar. 21, 2012

(30) Foreign Application Priority Data
Jul. 3, 2009 (AT) A 1044/2009
Jul. 6, 2009 (AT) A 1058/2009
Apr. 9, 2010 (AT) A 570/2010
May 28, 2010 (AT) A 876/2010

(51) Int. Cl. C08K 5/5398

(52) U.S. Cl. 521/85

(57) ABSTRACT

The invention relates to flameproof expandable polymers containing at least one blowing agent, wherein at least one phosphorus compound is contained as a flame retardant. Novel 9,10-dihydro-9-oxa-10-phosphaphenanthrene derivatives, namely 9,10-dihydro-9-oxa-10-phosphaphenanthrene-10-thione, 9,10-dihydro-10-hydroxy-9-oxa-10-phosphaphenanthrene-10-thione, 9,10-dihydro-10-hydroxy-9-oxa-10-phosphaphenanthrene-10-thione ammonium salt, 9,10-dihydro-10-mercapto-9-oxa-10-phosphaphenanthrene-10-thione, 9,10-dihydro-10-mercapto-9-oxa-10-phosphaphenanthrene-10-thione triethylammonium salt, 9,10-dihydro-10-hydroxy-9-oxa-10-phosphaphenanthrene-10-thione triethylammonium salt, 9,10-ei-hydro-10-hydroxy-9-oxa-10-phosphaphenanthrene-10-thione melaminium salt, 9,10-dihydro-10-hydroxy-9-oxa-10-phosphaphenanthrene-10-thione guanidinium salt, bis(9,10-dihydro-9-oxa-10-oxo-10-phosphaphenanthrene-10-yl)sulfide, 9,10-dihydro-10-(9,10-dihydro-9-oxa-10-phospha-10-thioxophenanthrene-10-ylthio)-9-oxa-10-phosphaphenanthrene-10-one, bis(9,10-dihydro-9-oxa-10-phospha-10-thioxophenanthrene-10-yl)sulfide, bis(9,10-dihydro-9-oxa-10-phospha-10-thioxophenanthrene-10-yl)disulfide, bis(9,10-dihydro-9-oxa-10-phospha-10-thioxophenanthrene-10-yl)tetrasulfide, di(9,10-dihydro-9-oxa-10-phospha-10-thioxophenanthrene-10-yl)ether and/or 9,10-dihydro-10-(9,10-dihydro-9-oxa-10-phospha-10-thioxophenanthrene-10-yloxy)-9-oxa-10-phosphaphenanthrene-10-one, or ring-opened hydrolyzates thereof, are provided as flame retardants.

The present invention relates to flameproof expandable polymerizates containing at least one blowing agent, which contain at least one novel derivative of 9,10-dihydro-9-oxa-10-phosphaphenanthrene-10-one or -10-oxide as a flame retardant.

The invention also relates to polymeric foams protected with these flame retardants, methods of producing the same, as well as the use of the above-mentioned flame retardants especially in expandable polymerizates and polymeric foams.

### PRIOR ART

9,10-Dihydro-9-oxa-10-phosphaphenanthrene-10-one or -10-oxide (DOPO)

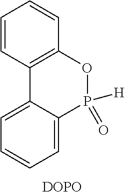

is a flame retardant that has been known and used since the early 1970s and was first described by Sanko Chemical Co. Ltd. in DE 20 34 887. This document generally discloses a group of 9,10-dihydro-9-oxa-10-phosphaphenanthrene derivatives of the following formulae:

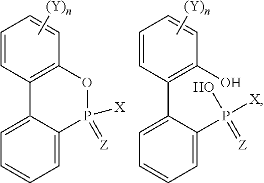

wherein compounds of the latter formula are products of ring-opening hydrolysis, and wherein the symbols have the following meanings:
Z is oxygen, sulfur or not present;
X is hydrogen, chlorine, methyl or phenoxy;
Y is hydrogen, chlorine or C₁₋₄-alkyl; and
n=0, 1 or 2.

Furthermore, the above document discloses the preparation of the compounds by reaction of ortho-phenylphenole derivatives with phosphorus trichloride, triphenyl phosphite, phenoxydichlorophosphine or diphenoxychlorophosphine as well as the use thereof as flame retardants (amongst others). The only sulfur-containing derivative prepared and analyzed in the examples is “DOPS-OPh” according to the following reaction:

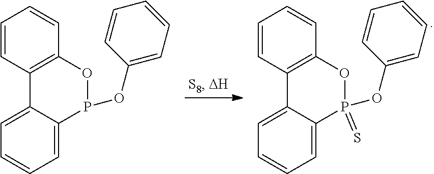

The abbreviation “DOPS” represents the sulfur analogue of DOPO, i.e. 9,10-dihydro-9-oxa-10-phosphaphenanthrene-10-sulfide or -10-thione:

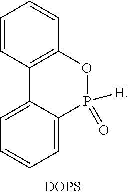

Since then, a plurality of derivatives based on the oxaphosphaphenanthrene ring system have been described in patent literature for use as fire-protection materials.

For example, Shinichi et al. disclose in U.S. Pat. No. 4,198,492 (to Asahi Dow) the use of DOPO derivatives of the following formula as fire-protection materials in polyphenylene ether resins:

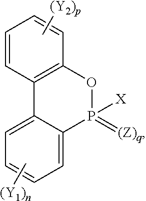

wherein the symbols have the following meanings:
Z is oxygen or sulfur;
q=0 or 1;
X is hydrogen, a hydroxyl group, an amino group, a halogen atom, C₁₋₁₀ alkyl, C₁₋₁₀ alkoxy, C₁₋₁₀ alkylthio or optionally hydroxy-substituted C₆₋₁₀ aryloxy;
Y₁ and Y₂ represent C₁₋₈ alkyl, C₁₋₈ alkoxy or an aryl group; and
n and p are integers of 0 to 4.

As specific examples of compounds with Z=sulfur, derivatives are mentioned, wherein X═H, alkoxy and aryloxy, explicitly including DOPS. The only sulfur-containing derivative mentioned, however, is the following compound:

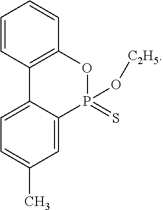

This substance is not further characterized, though, but is merely incorporated into a resin mixture the properties of which are examined, which, amongst others, yielded an average result in the ignition time measurement.

The derivative “DOPS-Cl” is also disclosed in several documents:

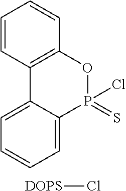

For example, Chernyshev et al., Zhurnal Obshchei Khimii 42(1), 93-6 (1972), describe the reaction of DOP-Cl with sulfur to give DOPS-Cl, and Bhatia et al., Chemistry & Industry 24, 1058 (1975) describe the preparation of DOPS-Cl from PSCl₃ and ortho-phenylphenol.

US 2008/153950 (The Dow Chemical Company) generally discloses the use of phosphorus-sulfur compounds of the following formula as flame retardants in polymers:

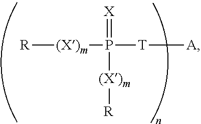

wherein X and X′ are oxygen or sulfur; m=0, 1 or 2; T is a covalent bond, oxygen, sulfur or —NR⁴—; wherein at least one of X and T is sulfur; the radicals R are hydrocarbon groups optionally linked to each other; A is an organic linker group; and n is an integer of at least 1, preferably at least 2. Preferably, the compounds correspond to the following formulae:

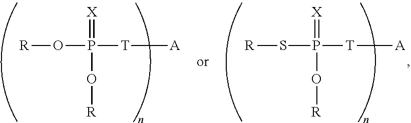

wherein, in some embodiments, the following structure can be construed:

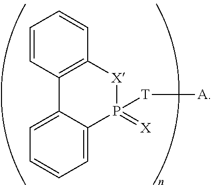

The organic linker group A may be an n-valent, linear or branched, optionally substituted alkylene residue, which in some cases might also contain phosphorus. A short-chain example of a divalent linker which is mentioned several times is the group —CH₂—CH═CH—CH₂— (2-butenylene). The synthesis of such phosphaphenanthrene derivatives shown immediately above wherein X and X′═O and T=S is done by reaction of DOPO with elemental sulfur and halogen derivatives of the respective linker. Phosphaphenanthrene derivatives with X or X′═S are not specifically described nor produced.

WO 2009/035881 to Dow Global Technologies describes flame-retardant polymer compositions wherein various phosphorus-containing compounds are used as active components. In this regard, mainly structures of a plurality of compounds with four heteroatoms, either oxygen or sulfur, bound to phosphorus are described, i.e., more specifically, salts and esters of phosphoric acid as well as various thio- and thionephosphoric acids, optionally in a polymeric form.

These include the structures of dimers of DOPS wherein two DOPS molecules are linked via a sulfide or disulfide bridge instead of hydrogen (i.e. “DOPS-S-DOPS” or “DOPS-S₂-DOPS”) as well as analogues thereof wherein the oxygen of dihydrooxaphosphaphenanthrene (DOP) is replaced by sulfur, i.e. dihydrophosphasulfaphenanthrene (DPS) derivatives (i.e. “DPSS-S-DPSS” or “DPSS-S₂-DPSS”).

However, in WO 2009/035881 not a single DOPO derivative but only non-aromatic compounds were actually produced and characterized and, thus, reproducibly disclosed.

Therefore, it is known from literature that DOPO and various derivatives thereof have good flame-retardant properties, wherein this effect seems to be based on the fact that these compounds release phosphorus-containing free radicals when heated (see e.g. Seibold et al., J. Appl. Polym. Sci. 105(2), 685-696 (2007)). However, it would be desirable to have novel substances with further increased flame retardancy, especially such substances improving gas-phase activity.

The preparation of further derivatives may, for example, be based on DOP-Cl. In this regard, Ciesielski et al., Polymers for Advanced Technologies 19, 507 (2008) describe the preparation of DOP-NHPr starting from DOP-Cl. Further, more general reactions of phosphites, alkyl phosphites and chlorophosphites are, for example, described in the following literature: U.S. Pat. No. 2,805,241 (Ciba) describes the reaction of dialkyl and diaryl chlorophosphites with hydrogen sulfide and stoichiometric amounts of a base. U.S. Pat. No. 4,220,472 (Sandoz) describes the hydrolysis of the moiety Cl—P═S. For example, the flame retardant Sandoflam®, commercially available from Clariant, is manufactured in this way. Kabatschnik et al., Chem. Zentralbl. 127, 11232 (1956), and Borecki et al., J. Chem. Soc. 1958, 4081-4084 describe the reaction of the H—P═O moiety with sulfur. And Seeberger et al., Tetrahedron 55(18), 5759-5772 (1999) show examplary reactions of the moiety H—P═S with sulfur as well as its oxidation with iodine in combination with water.

In WO 99/10429 (Albemarle) it is generally disclosed that the combined use of, optionally sulfur-containing, organophosphorus compounds and elemental sulfur as flame retardants in styrenic polymers leads to improved fire-protection properties. DOPO and derivatives thereof are not mentioned therein, though.

Modifying polymeric foams or foamed polymers with flame retardants is important in a plurality of applications, for example in polystyrene particle foams of expandable polystyrene (EPS) or in extruded polystyrene (XPS) foam sheets for isolating buildings. Until now, mostly halogen-containing, especially brominated organic compounds such as hexabromocyclododecane (HBCD) have been used for polystyrene homo- and copolymers. However, some of these brominated substances are under consideration or have already been prohibited because of potential environmental and health hazards.

Known alternatives are various halogen-free flame retardants. However, in order to achieve the same flame-retardant effects as with halogen-containing flame-retardants, halogen-free flame retardants usually have to be applied in substantially higher amounts.

This is one reason why, frequently, halogen-free flame retardants that may be used in compact thermoplastic polymers cannot be used in a similar way in polymeric foams, since they either interfere with the foaming process or affect the mechanical and thermal properties of the polymeric foam. In the manufacture of expandable polystyrene via suspension polymerization, high amounts of flame retardants may also reduce the stability of the suspension and thus interfere with or affect the manufacturing method.

The effect of flame retardants used for compact polymers on polymeric foams is often unpredictable because of peculiarities of such foams and their different fire behavior or because of differing fire tests.

In prior art, WO 2006/027241 describes halogen-free flame retardants for polymeric foams, which have no substantial effect on the foaming process and the mechanical properties and allow the production of mainly closed-cell polymeric foams, too. These flame retardants are phosphorus compounds that have been known and used since the early 1970s and which are, for example, produced according to JP-A 2004-035495, JP-A 2002-069313 or JP-A 2001-115047. Particularly preferred is the above phosphorus oxide, 9,10-dihydro-9-oxa-10-phosphaphenantrene-10-oxide (6H-dibenz[c,e]-oxaphosphorine-6-oxide, DOP-O, CAS [35948-25-5]).

With this flame retardant, however, also relatively high concentrations of flame retardant are required in order to obtain a product of sufficient quality, and these high concentrations have a strong effect on the foam structure and the stability of the matrix. Furthermore, the European fire class E, tested according to EN 11925, or B1, tested according to DIN 4102, cannot be achieved.

It is thus an object of the present invention to provide a halogen-free, flameproof expandable polymerizate of nevertheless high quality, which contains a particular flame retardant that is only required in minor amounts and/or that has no substantial effect on the subsequent foaming process and the mechanical properties of the foam.

Furthermore, it is an object of the invention to provide an advantageous method of producing such polymerizates.

A further object of the invention is to provide a halogen-free, flameproof, polymeric foam of nevertheless high quality, having an advantageous fire behavior and good mechanical properties, as well as an advantageous method of producing the same.

### DISCLOSURE OF THE INVENTION

Current research has shown that a group of compounds corresponding to the following formula I show increased flame-retardant effects when compared to DOPO and other comparative substances:

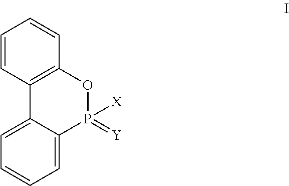

wherein:
X is selected from hydrogen, OH and SH, and alkali metal, alkaline earth metal, ammonium and phosphonium salts thereof, as well as divalent linker groups Zₙ linking two identical or different dihydrooxaphosphaphenanthrenyl residues to give a dimer of the following formula II:

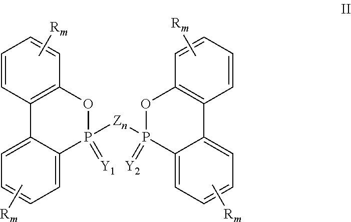

Y, Y₁, Y₂ and Z independently represent oxygen atoms or sulfur atoms; with the provision that at least one of X and Y in formula I and at least one of Y₁, Y₂ and Z in formula II represent(s) or contain(s) a sulfur atom;
n is an integer of at least 1, wherein n=1 when Z is an oxygen atom and n=1 to 8 when Z is a sulfur atom;
each R independently represents an optionally substituted alkyl, alkoxy or alkylthio group of 1 to 8 carbon atoms or an optionally substituted aryl group; and
each m independently represents an integer of 0 to 4.

Ring-opened hydrolyzates of such compounds, as mentioned above, also show flame-retardant properties.

Herein, the “alkyl” portion of the optional substituents R of inventive compounds means both saturated and unsaturated aliphatics which may be linear or branched, unsaturated groups being preferred. The substituents R preferably comprise short-chain alkyl groups with not more than 6, more preferably not more than 4 or 3, even more preferably not more than 2, carbon atoms or phenyl as an aryl group, and m is preferably 0 to 2 because longer-chain residues, a high degree of saturation and a higher number of substituents may have a disadvantageous effect on the flame-retardant effect. Most preferably, m=0, i.e. the inventive compounds are most preferably unsubstituted.

Preferably, if substituents R are present, they bear a sulfur-containing substituent such as —SH, —SO₃NH₄, —SO— or —SO₂— or a phosphorus-containing substituent such as —PO(ONH₄)₂ or the like, in order to further improve the flame-retardant effect.

Among the optional salts of any SH or OH groups of the inventive compounds, ammonium and phosphonium salts are preferred because they may also contribute to the flame-retardant effect. The ammonium and phosphonium ions may bear up to four organic residues, e.g. the substituents R as defined above, instead of hydrogen atoms (i.e. NR₄⁺ or PR₄⁺), hydrogen being the preferred substituent in the case of ammonium, though.

These flame-retardants enabled the production of polymerizates and polymeric foams showing improved flame-retardancy, which, among other things and without wishing to be bound by any particular theory, was based on an increased gas-phase activity, as well as improved properties. Furthermore, comparatively low amounts suffice to achieve the same effects.

In a first aspect, the invention thus relates to novel, flameproof, blowing agent-containing, expandable or foamable polymerizates containing at least one of the following phosphorus compounds, or ring-opened hydrolyzates or salts thereof, as (a) flame retardant(s), in particular several novel 9,10-dihydro-9-oxa-10-phosphaphenanthrene derivatives of formula I

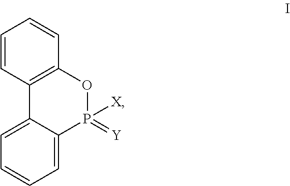

namely a compound of formula I wherein X is hydrogen and Y is sulfur, i.e. 9,10-dihydro-9-oxa-10-phosphaphenanthrene-10-thione or -10-sulfide (“DOPS”):

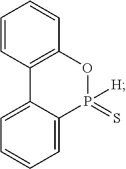

a compound of formula I wherein X is OH and Y is sulfur, i.e. 9,10-dihydro-10-hydroxy-9-oxa-10-phosphaphenanthrene-10-thione or -10-sulfide (“DOPS-OH”):

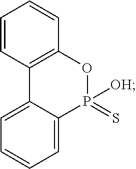

a compound of formula I wherein X is ONH₄ and Y is sulfur, i.e. 9,10-dihydro-10-hydroxy-9-oxa-10-phosphaphenanthrene-10-thione or -10-sulfide ammonium salt (“DOPS-ONH₄”):

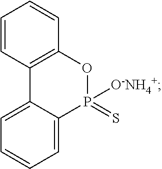

a compound of formula I wherein X is SH and Y is sulfur, i.e. 9,10-dihydro-10-mercapto-9-oxa-10-phosphaphenanthrene-10-thione or -10-sulfide (“DOPS-SH”):

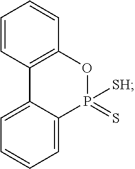

a compound of formula I wherein X is SNH(Et)₃ and Y is sulfur, i.e. 9,10-dihydro-10-mercapto-9-oxa-10-phosphaphenanthrene-10-thione or -10-sulfide triethylammonium salt (“DOPS-SNH(Et)₃”):

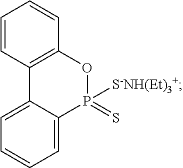

a compound of formula I wherein X is ONH(Et)₃ and Y is sulfur, i.e. 9,10-dihydro-10-hydroxy-9-oxa-10-phosphaphenanthrene-10-thione or -10-sulfide triethylammonium salt (“DOPS-ONH(Et)₃”):

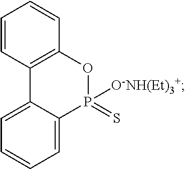

a compound of formula I wherein X is OMel and Y is sulfur, i.e. 9,10-dihydro-10-hydroxy-9-oxa-10-phosphaphenanthrene-10-thione or -10-sulfide melaminium salt (“DOPS-OMel”):

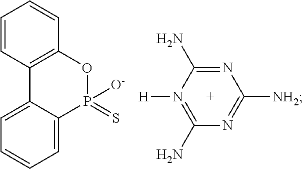

and
a compound of formula I wherein X is OGua and Y is sulfur, i.e. 9,10-dihydro-10-hydroxy-9-oxa-10-phosphaphenanthrene-10-thione or -10-sulfide guanidinium salt (“DOPS-OGua”):

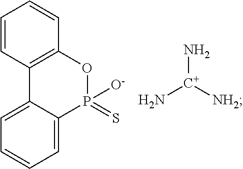

as well as several novel 9,10-dihydro-9-oxa-10-phosphaphenanthrene derivatives of formula I wherein X is a divalent linker group Zₙ linking two dihydrooxaphosphaphenanthrenyl residues of formula I to give a dimer of formula II

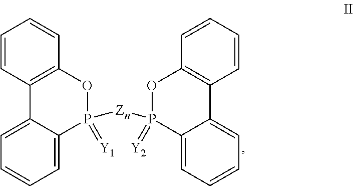

namely a compound of formula II wherein Y₁ and Y₂ are each oxygen, Z is sulfur and n=1, i.e. bis(9,10-dihydro-9-oxa-10-oxo-10-phosphaphenanthrene-10-yl)-sulfide (“DOPO-S-DOPO”):

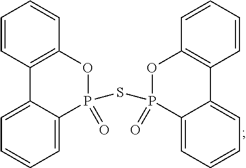

a compound of formula II wherein Y₁ and Z are each sulfur, Y₂ is oxygen and n=1, i.e. 9,10-dihydro-10-(9,10-dihydro-9-oxa-10-phospha-10-thioxophenanthrene-10-ylthio)-9-oxa-10-phosphaphenanthrene-10-one or -10-oxide (“DOPS-S-DOPO”):

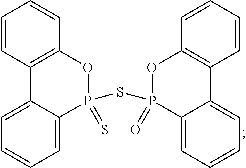

a compound of formula II wherein Y₁, Y₂ and Z are each sulfur and n=1, i.e. bis(9,10-dihydro-9-oxa-10-phospha-10-thioxophenanthrene-10-yl)sulfide (“DOPS-S-DOPS”):

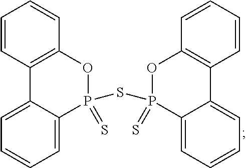

a compound of formula II wherein Y₁, Y₂ and Z are each sulfur and n=2, i.e. bis(9,10-dihydro-9-oxa-10-phospha-10-thioxophenanthrene-10-yl)disulfide (“DOPS-S₂-DOPS”):

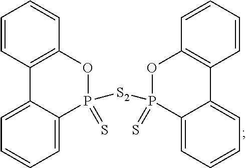

a compound of formula II wherein Y₁, Y₂ and Z are each sulfur and n=4, i.e. bis(9,10-dihydro-9-oxa-10-phospha-10-thioxophenanthrene-10-yl)tetrasulfide (“DOPS-S₄-DOPS”):

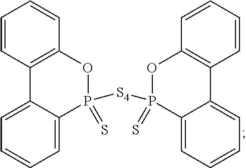

a compound of formula II wherein Y₁ and Y₂ are each sulfur, Z is oxygen and n=1, i.e. di(9,10-dihydro-9-oxa-10-phospha-10-thioxophenanthrene-10-yl)ether (“DOPS-O-DOPS”):

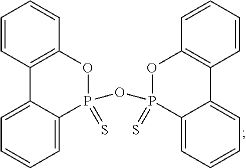

and
a compound of formula II wherein Y₁ is sulfur, Y₂ and Z are each oxygen and n=1, i.e. 9,10-dihydro-10-(9,10-dihydro-9-oxa-10-phospha-10-thioxophenanthrene-10-yloxy)-9-oxa-10-phosphaphenanthrene-10-one or -10-oxide (“DOPS-O-DOPO”):

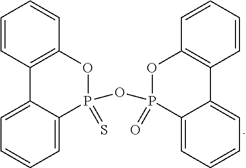

Since a person skilled in the art may easily hydrolyze the cyclic phosphonic or phosphinic acid ester of the inventive compounds of formulae I and II under appropriate conditions, “ring-opened hydrolyzates” are also within the scope of the invention. Consequently, these represent compounds containing the following structure:

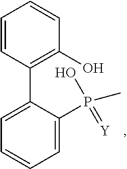

wherein this structure may also be present in one or both of the monomer units of dimers according to the above formula II, so that such dimers are likewise covered by the definition of “ring-opened hydrolyzates” since such hydrolsates may also be effective as flame retardants.

While the structure of some of the above compounds is comprised in formulae mentioned in the literature, until now none of them has been explicitly described, actually synthesized or further characterized. For example, DOPS is comprised in the formulae of DE 20 34 887 and U.S. Pat. No. 4,198,492, the latter also comprising DOPS-OH. As mentioned above, the structures DOPS-S-DOPS and DOPS-S₂-DOPS have already been formally described in WO 2009/035881, but these compounds were neither synthesized nor further characterized. This has only been achieved now, and it has only now been discovered that these special compounds have better flame-retardant properties than other, related examples of the groups of compounds disclosed, and that they show a synergistic effect with elemental sulfur and other sulfur-containing compounds.

As later shown in the examples, the above novel compounds, alone or as a mixture of several thereof or contained in a flame-retardant composition, show very good flame-retardant properties. Using these flame retardants, it was possible to create polymerizates and polymeric foams showing improved flame retardancy and improved properties. Furthermore, comparatively minor amounts—that do not affect foaming—suffice to achieve the same effect.

An advantageous embodiment of the invention is characterized by the surprising finding that the novel compounds show a synergistic effect as flame retardants in combination with elemental sulfur and other sulfur-containing compounds.

Expandable polymerizates obtained in this way are characterized by that the at least one flame retardant is used in combination with elemental sulfur and/or a further sulfur-containing compound or sulfur compound, especially in an amount of 0.1 to 10 wt %, especially in an amount of about 0.5 to 5 wt %, preferably about 2 wt %, based on the total weight of the polymer. Especially preferably, this additional sulfur-containing compound comprises at least one S—S bond, wherein at least one of the sulfur atoms is divalent.

Preferred sulfur compounds used are, for example, sulfides, sulfites, sulfates, sulfanes, sulfoxylates, sulfones, sulfonates, thiosulfates, thionites, thionates, disulfates, sulfoxides, sulfur nitrides, sulfur halides and/or organosulfur compounds such as thiols, thioethers, thiophenes.

In addition, sulfur compounds have shown to be advantageous that have a weight loss of less than 10 wt % below 115° C. in a thermogravimetric analysis (TGA) according to EN ISO 11358, e.g. ammonium thiosulfate, dicaprolactam disulfide, zinc sulfide, polyphenylene sulfide, etc.

Especially preferably, the sulfur-containing compound or sulfur compound comprises at least one S—S bond, wherein at least one of the sulfur atoms is divalent, e.g. disulfite, dithionite, cystine, amyl phenole disulfide, poly(tert-butyl phenol disulfide) etc.

Comparative experiments clearly show that the novel compounds of the present invention when used in combination with elemental sulfur or sulfur-containing compounds, with which they show a synergistic effect, result in substantially increased flame retardancy compared to the known DOPO additive.

Preferably, the halogen-free, flameproof polymeric foams contain a thermoplastic polymer, especially a styrene polymer.

The inventive expandable polymerizates are preferably expandable styrene polymerizates (EPS) or expandable granular styrene polymer (EPS). Advantageously, they consist of homo- and copolymers of styrene, preferably crystal-clear polystyrene (GPPS), high-impact polystyrene (HIPS), anionically polymerized polystyrene or impact-resistant polystyrene (A-IPS), copolymers of styrene and alpha-methylstyrene, acrylonitrile-butadiene-styrene polymerizates (ABS), styrene-acrylonitrile (SAN), acrylonitrile-styrene-acrylic ester (ASA), methylacrylate-butadiene-styrene (MBS), methylmethacrylate-acrylonitrile-butadiene-styrene (MABS) polymerizates or mixtures thereof or mixtures with polyphenylene ether (PPE). Especially with regard to polystyrene, demand for high-quality products is strong.

For improving mechanical properties or temperature resistance, the styrene polymers mentioned may be mixed, optionally using compatibilizers, with thermoplastic polymers such as polyamides (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfones (PES), polyether ketones, or polyether sulfides (PES), or mixtures thereof, usually in proportions of a maximum of 30 wt % in total, preferably in the range of 1 to 10 wt %, based on the polymer melt.

Additionally, mixtures in the above amount ranges can also be prepared with e.g. hydrophobically modified or functionalized polymers or oligomers, rubbers such as polyacrylates or polydienes, e.g. styrene-butadiene block copolymers, or biodegradable aliphatic or aliphatic/aromatic copolyesters.

Suitable compatibilizers are, for example, maleic anhydride-modified styrene copolymers, epoxide group-containing polymers or organosilanes.

An advantageous embodiment of expandable polymerizates comprises the use of the compounds either alone as flame retardants, e.g. in plastic materials, wherein they are preferably present in an amount of 0.1 to 25 wt %, preferably 3 to 10 wt %, based on the total weight of the polymer, or as components of a flame retardant composition which may additionally contain any further components commonly used in such compositions. These include, for example, organic peroxides, e.g. dicumyl peroxide, metal hydroxide, nitrogen compounds, e.g. melamines, nanoparticles, etc.

The efficacy of the phosphorus compounds can be further improved by adding appropriate flame retardancy synergists such as the thermal radical formers dicumyl peroxide, di-tert-butyl peroxide or dicumyl.

Also, various additional flame retardants such as melamine, melamine cyanurates, metal oxides, metal hydroxides, phosphates, phosphinates, or synergists such as Sb₂O₃ or Zn compounds may be used.

In cases where the polymerizate or polymeric foam does not have to be entirely halogen-free, halogen-reduced foams may be produced by using the phosphorus compounds and adding minor amounts of halogen-containing, especially brominated flame retardants such as hexabromocyclodecane (HBCD), preferably in amounts in the range of 0.05 to 1, especially 0.1 to 0.5, wt %.

The halogen-free, flameproof polymeric foams preferably have a density in the range of 8 to 200 g/L, especially preferably in the range of 10 to 50 g/L, and their closed-cell portion is preferably more than 80%, especially preferably 95 to 100%.

A further aspect of the invention relates to the preparation of such polymerizates. According to the invention, the flameproof expandable polymerizates mentioned above can be produced as generally known by admixing the above flame retardants and optionally sulfur and/or at least one sulfur-containing compound or sulfur compound.

An advantageous procedure comprises mixing the flame retardant and a blowing agent with a styrene polymer melt using a dynamic or static mixer and subsequent granulation.

Alternatively, it may be provided that the flame retardant is mixed into a still granular polystyrene polymerizate using a dynamic or static mixer and then melted, and that the melt is subsequently impregnated and granulated.

Alternatively, it may further be provided that granulation is achieved by suspension polymerization of styrene in an aqueous suspension in the presence of the flame retardant and a blowing agent.

Sulfur and/or at least one sulfur-containing compound or sulfur compound is added simultaneously with the flame retardant.

A further inventive method for producing the inventive flameproof expandable styrene polymerizates (EPS) comprises the following steps:
jointly dosing granular PS or EPS having a molecular weight of Mw >120,000 g/mol, preferably 150,000 to 250,000 g/mol, more preferably 180,000 to 220,000 g/mol, the flame retardant, and optionally one or more further additives, into an extruder,
jointly melting all components in the extruder,
optionally adding at least one blowing agent,
mixing all components at a temperature >120° C.,
granulation by means of pressurized underwater granulation, e.g. at 1-20 bar, to a granule size <5 mm, preferably 0.2 to 2.5 mm, at a water temperature of 30 to 100° C., most preferably 50 to 80° C.,
optionally coating the surface with coating agents, e.g. silicates, metal salts of fatty acids, fatty acid esters, fatty acid amides.

The inventive halogen-free, flameproof expandable styrene polymers (EPS) and styrene polymer extruded foams (XPS) may be produced by admixing a blowing agent and one or more of the above phosphorus compounds or hydrolyzates or salts thereof, and optionally sulfur and/or at least one sulfur-containing compound or sulfur compound, into the polymer melt and subsequent extrusion to give foam sheets, foam strands, or expandable granules.

Preferably, the expandable styrene polymer has a molecular weight >120,000, more preferably in the range of 180,000 to 220,000 g/mol. Due to a decrease in molecular weight because of shearing and/or temperature effects, the molecular weight of the expandable polystyrene is usually about 10,000 g/mol lower than the molecular weight of the polystyrene used.

Further, recycled polymers of the thermoplastic polymers mentioned, especially styrene polymers and expandable styrene polymers (EPS), may be added to the styrene polymer melt, i.e. in amounts that do not substantially deteriorate their properties, usually in amounts of maximum 50 wt %, especially in amounts of 1 to 20 wt %.

The blowing agent-containing styrene polymer melt usually contains one or more homogeneously distributed blowing agent(s) in a proportion of 2 to 10 wt % in total, preferably 3 to 7 wt %, based on the blowing agent-containing styrene polymer melt. Suitable blowing agents are physical blowing agents usually used in EPS such as aliphatic hydrocarbons of 2 to 7 carbon atoms, alcohols, ketones, ethers or halogenated hydrocarbons. Preferably, iso-butane, n-butane, iso-pentane, or n pentane is used. For XPS, preferably CO₂ or mixtures thereof with alcohols or ketones are used.

The amount of blowing agent added is selected so that the expandable styrene polymers (EPS) have an expansivity of 7 to 200 g/L, preferably 10 to 50 g/L.

The inventive expandable granular styrene polymer (EPS) usually has a bulk density of not more than 700 g/L, preferably in the range of 590 to 660 g/L.

Furthermore, additives, nucleation agents, fillers, plasticizers, soluble and insoluble inorganic and/or organic dyes and pigments, e.g. IR absorbers such as carbon black, graphite or aluminum powder, may be added to the styrene polymer melt, jointly or in a spatially separated way, e.g. via mixers or side extruders. Usually, the dyes and pigments are added in amounts in the range of 0.01 to 30, preferably in the range of 1 to 10, wt %. For a homogeneous and microdisperse distribution of the pigments in the styrene polymer, it may be useful, especially for polar pigments, to use a dispersing agent, e.g. organosilanes, epoxy group-containing polymers, or maleic anhydride-grafted styrene polymers. Preferred plasticizers are mineral oils, phthalates, which are used in amounts of 0.05 to 10 wt %, based on the styrene polymerizate.

A further aspect of the invention relates to a polymeric foam, especially a styrene polymeric particle foam or an extrudable polystyrene rigid foam (XPS), containing at least one of the above phosphorus compounds or ring-opened hydrolyzates or salts thereof as (a) flame retardant(s).

Advantageously, sulfur and/or at least one sulfur-containing compound or sulfur compound may additionally be contained.

This polymeric foam is obtainable from the inventive flameproof expandable polymerizates, especially from expandable styrene polymerizates (EPS), especially by foaming and caking the polymerizates or by extrusion.

An especially preferred polymeric foam has a density between 7 and 200 g/L and has a mostly closed-cell cell structure with more than 0.5 cells per mm³.

According to the invention, at least one of the phosphorus compounds or ring-opened hydrolyzates or salts thereof mentioned is used as (a) flame retardant(s) in expandable polymerizates, especially in expandable styrene polymerizates (EPS) or expandable granular styrene polymers (EPS), or in polymeric foams, especially in styrene polymeric particle foams, obtainable by foaming from expandable polymerizates, or in extruded polystyrene rigid foams (XPS).

For producing a flameproof extruded polystyrene rigid foam (XPS), the flame retardant(s) and a blowing agent, and optionally sulfur and/or at least one sulfur-containing compound or sulfur compound, are mixed with a styrene polymer melt using a dynamic or static mixer and then foamed, or the flame retardant is added using a dynamic or static mixer to a still granular polystyrene polymerizate and then molten, whereafter the melt is impregnated and foamed.

To enable the artisan to reproduce these polymerizates and foams, the following should be preliminarily mentioned:

### Production of the Flame Retardants and Derivatives Thereof:

The inventive flame retardants and derivatives thereof may, for example, be produced by reacting a 9,10-dihydro-9-oxa-10-phosphaphenanthrene (DOP-) derivative, selected from DOPO, DOP-Cl, DOPS, DOPS-Cl and DOP-NHPr, with elemental sulfur or a sulfur-containing compound to obtain the desired compound. By means of such syntheses, flame retardants with very good yields and without any substantial formation of byproducts such as hydrolyzates or decomposition products may be obtained.

Especially preferred reactions for obtaining inventive compounds are shown below:

Reaction of DOP-Cl with hydrogen sulfide to give DOPS:

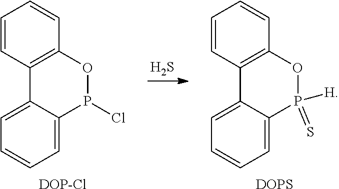

Reaction of DOPO with Lawesson's reagent or P₂S₅ to give DOPS:

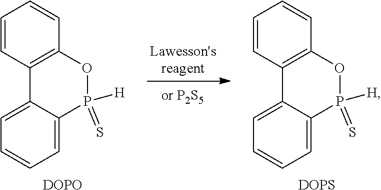

wherein Lawesson's reagent has the following structure:

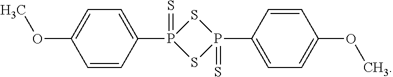

Reaction of DOPS-OH with aqueous ammonia to give DOPS-ONH₄:

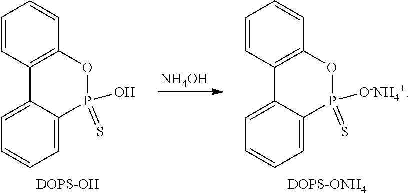

Reaction of DOP-NHPr with hydrogen sulfide to give DOPS:

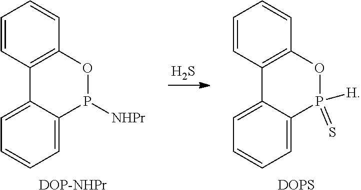

Reaction of DOPO with elemental sulfur to give DOPS-OH:

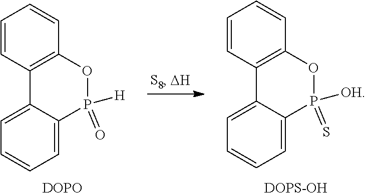

Reaction of DOPO with ammonium thiosulfate to give DOPS-ONH₄:

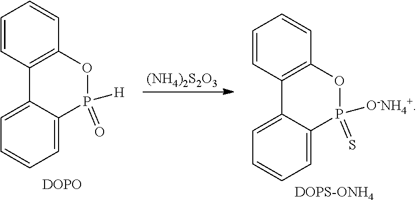

Reaction of DOPS with elemental sulfur to give DOPS-SH:

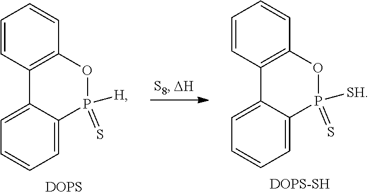

Reaction of DOPS-Cl with hydrogen sulfide to give DOPS-SH:

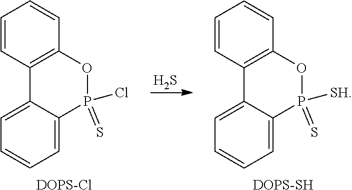

Reaction of DOPO with N,N′-dicaprolactam disulfide (bis(hexahydro-2-oxo-2H-azepine-1-yl)disulfide) to give a mixture of DOPO-S-DOPO and DOPS-S-DOPO:

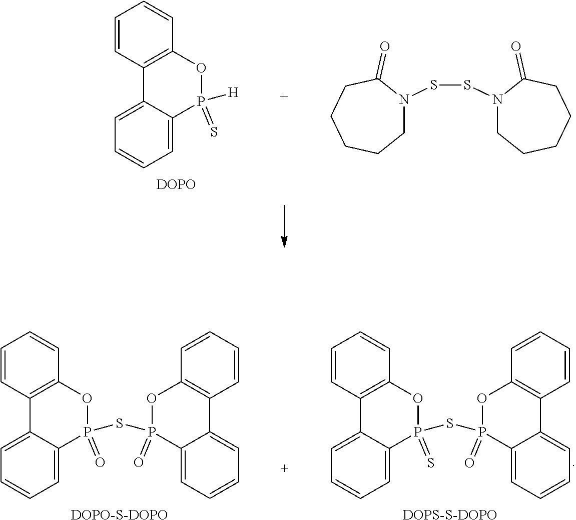

Reaction of DOPS-Cl with hydrogen sulfide to give DOPS-S-DOPS:

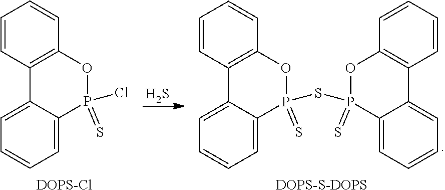

Reaction of DOPS with sulfur and triethylamine to give DOPS-SNH(Et)₃:

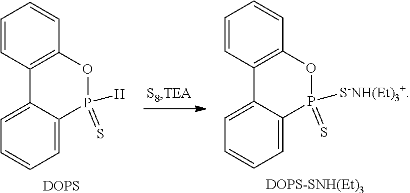

Reaction of DOPS-Cl with sulfur and triethylamine to give DOPS-SNH(Et)₃:

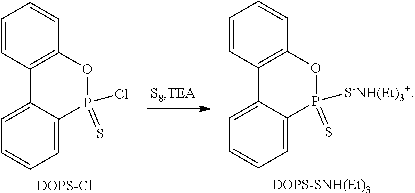

Reaction of DOPS-OH with triethylamine to give DOPS-ONH(Et)₃:

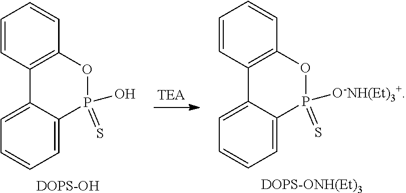

Reaction of DOPS-OH with melamine to give DOPS-OMel:

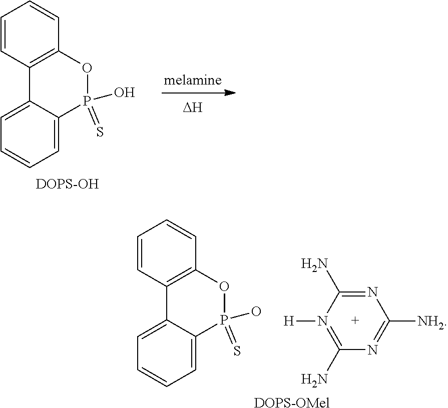

Reaction of DOPS-OH with guanidine carbonate to give DOPS-OGua:

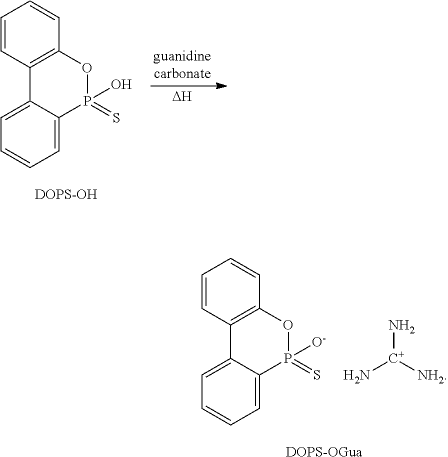

Dimerization of DOPS-SH to give DOPS-S-DOPS:

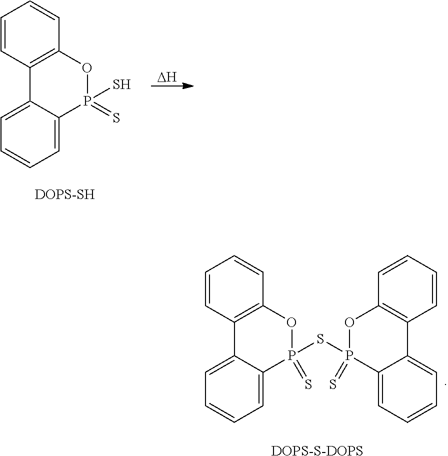

Reaction of DOPS-SNH(Et)₃ with hydrogen peroxide with simultaneous dimerization to give DOPS-S₂-DOPS:

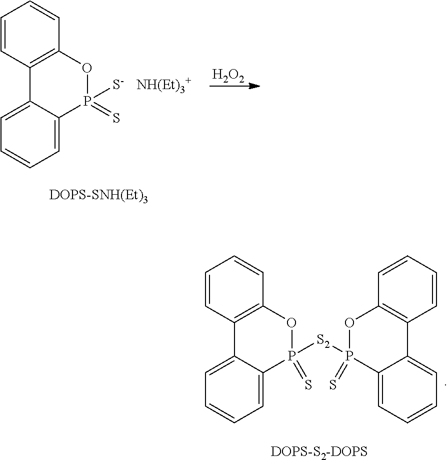

Reaction of DOPS-SNH(Et)₃ with disulfur dichloride to give DOPS-S₄-DOPS:

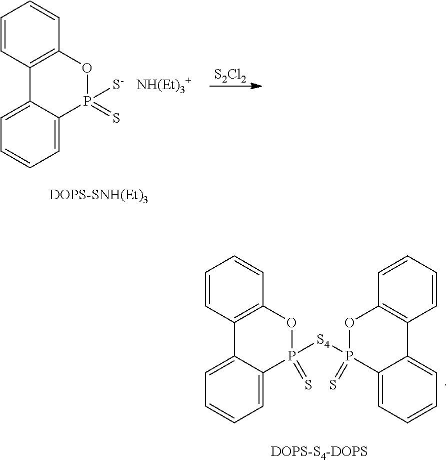

Reaction of DOP-Cl with DOPS-OH and triethylamine and subsequently with elemental sulfur to give DOPS-O-DOPS:

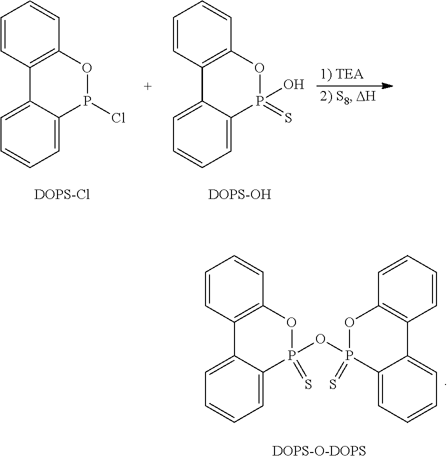

Reaction of DOP-Cl with DOPO-OH and triethylamine and subsequently with elemental sulfur to give DOPS-O-DOPO:

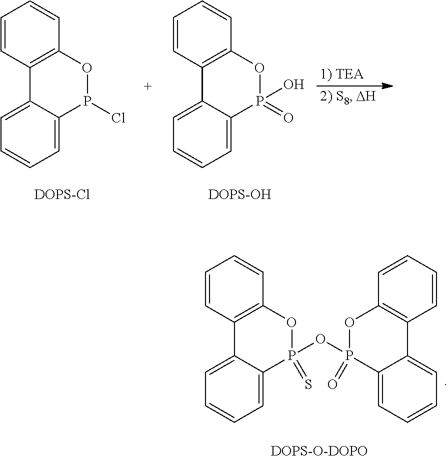

Reaction of DOP-Cl with DOPS-SNHEt₃ and subsequently with elemental sulfur to give DOPS-S-DOPS:

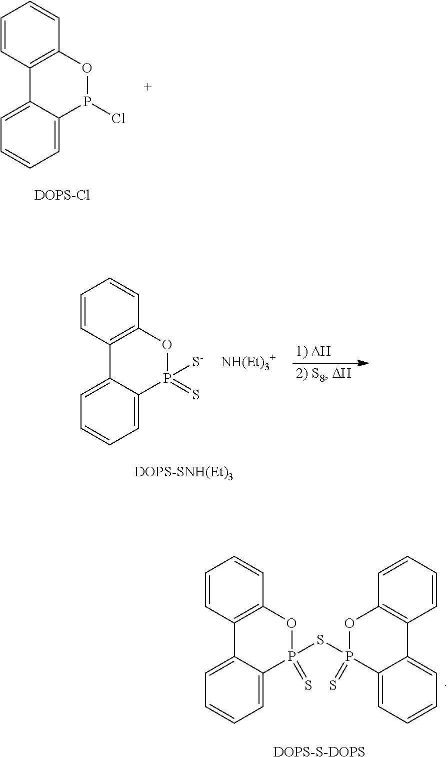

Finally, an alternative method for producing 9,10-dihydro-10-mercapto-9-oxa-10-phosphaphenanthrene-10-thione or -10-sulfide (“DOPS-SH”) is available in which DOPS-SNH(Et)₃ is hydrolyzed with HCl to give DOPS-SH:

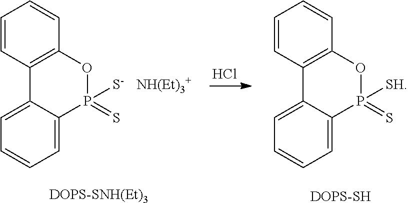

Of course, the flame-retardant compounds may also be obtained via other routes, and the average artisan, considering the special phosphorine chemistry, will be able to determine a number of alternative synthetic routes, whether routes already starting with a DOP derivative or routes where the dihydrooxaphosphaphenanthrene starting compound still has to be formed, e.g. similar to the synthesis starting from ortho-phenylphenol disclosed in DE 20 34 887.

Exemplary syntheses that already start from DOP derivatives are shown below.

Reaction of DOPS-Cl with a metal hydride to give DOPS:

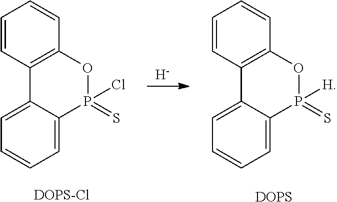

Reaction of DOPS-Cl with water or aqueous base to give DOPS-OH:

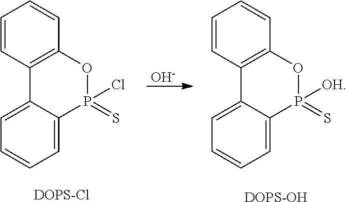

Reaction of DOPS with an organic or inorganic oxidant to give DOPS-OH:

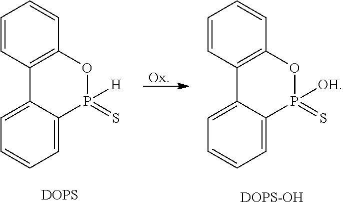

Reaction of DOPS-OH with aqueous ammonia to give DOPS-ONH₄:

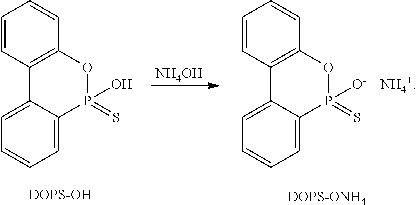

This synthesis can be conducted in an analogous way using DOPS-SH:

Reaction of DOPS-SH with aqueous ammonia to give DOPS-SNH₄:

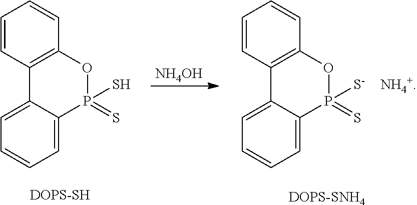

Alternatively, DOPS-OH and DOPS-SH may also be converted to the corresponding metal salts using diluted solutions of alkali or alkaline earth metal hydroxides or to the corresponding phosphonium salts using a solution of a phosphonium salt, e.g. a tetraalkyl phosphonium halide, or phosphate (preferably in the presence of a medium or strong auxiliary base), wherein, however, hydrolysis of the cyclic ester is to be avoided, if this is not desired, although—as mentioned above—such hydrolyzates of inventive compounds may also have flame-retardant effects.

Reaction of DOP-NHPr with hydrogen sulfide to give DOPS:

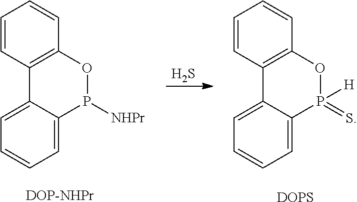

Reaction of DOPS-Cl with hydrogen sulfide to give DOPS-SH:

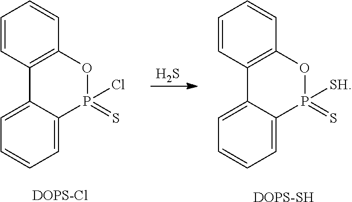

Reaction of DOPS-Cl with hydrogen sulfide to give DOPS-S-DOPS:

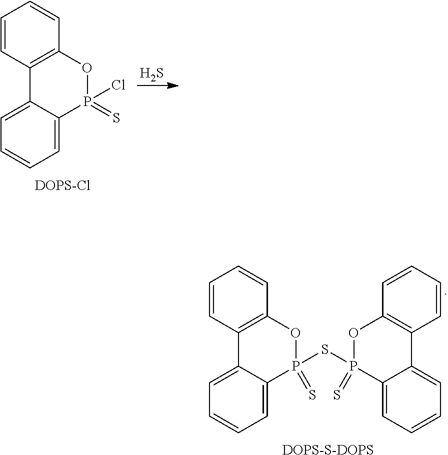

Reaction of DOPS-Cl with water to give DOPS-O-DOPS:

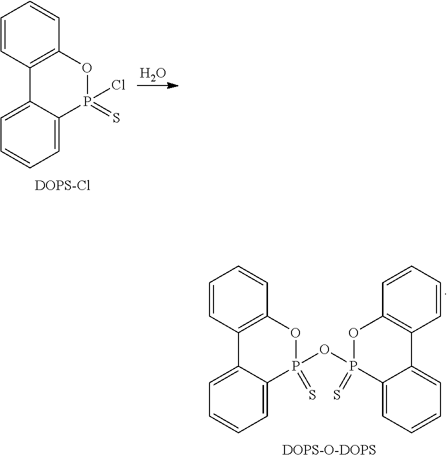

In order to enable the artisan to produce the flame retardants, the preparations of starting products relevant for the synthesis (cf. “Synthetic Examples”) and of the above flame retardants or derivatives thereof (“Examples”) are described in more detail in the following examples which should not be considered as a limitation.

### EXAMPLES

### Synthetic Example 1

### Preparation of 10-chloro-9,10-dihydro-9-oxa-10-phosphaphenanthrene (DOP-Cl)

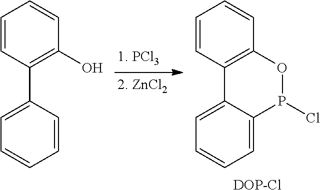

This starting product for the synthesis of inventive novel compounds was essentially produced according to literature (DE 20 34 887) from ortho-phenylphenol with PCl_{S} and by means of cyclization of the dichlorophosphite obtained as intermediate product using zinc chloride catalysis.

Yield: 94% of theory

### Synthetic Example 2

### Preparation of 10-chloro-9,10-dihydro-9-oxa-10-phosphaphenanthrene-10-thione or -10-sulfide (DOPS-Cl)

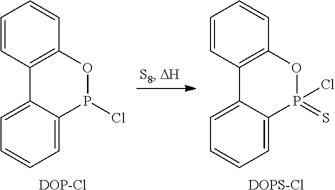

This starting product for the synthesis of inventive novel compounds was essentially produced according to literature (Chernyshev et al., Zhurnal Obshchei Khimii 42(1), 93-6 (1972)) from DOP-Cl with elemental sulfur.

Yield: 88% of theory

### Synthetic Example 3

### Preparation of 9,10-dihydro-9-oxa-10-phospha-10-propylaminophenanthrene (DOP-NHPr)

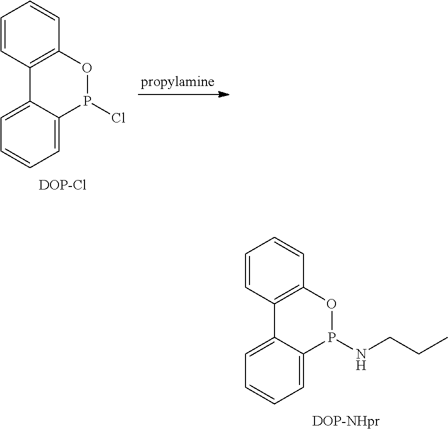

This starting product for the synthesis of inventive novel compounds was essentially produced according to literature (Ciesielski et al., Polymers for Advanced Technologies 19, 507 (2008)) from DOP-Cl and n-Propylamin.

Yield: 91% of theory

### Example 1

### Preparation of 9,10-dihydro-9-oxa-10-phosphaphenanthrene-10-thione or -10-sulfide (DOPS)

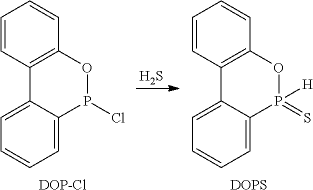

While flushing with an inert gas, 28.1 g (0.12 mol) of DOP-Cl were introduced into a round-bottomed flask equipped with a gas inlet tube, a thermometer, a dropping funnel, a mechanical agitator, and a gas outlet tube, whereafter 200 mL of toluene, free of air and moisture, were added. Once DOP-Cl had been completely dissolved, H₂S gas was introduced while stirring and maintaining the temperature at 25 to 30° C. After 2 h, 18.4 ml (13.4 g, 0.132 mol) of triethylamine were added, which resulted in the precipitation of a white solid (triethylamine hydrochloride). After further 30 min, the introduction of H₂S gas was discontinued, and 1.5 h later the agitator was stopped. The solid was filtered off, and the toluene was distilled off in vacuo. The remaining residue was recrystallized from acetonitrile. 23.7 g (85% of theory) of DOPS were obtained as a white crystalline solid.

Mp.: 92-94° C. (acetonitrile)

³¹P-NMR (CDCl₃): 58.7 ppm

MS: 232 (C₁₂H₉OPS)

Elemental analysis: calcd. P 13.35%. Found P 13.21%

### Example 2

### Preparation of 9,10-dihydro-10-hydroxy-9-oxa-10-phosphaphenanthrene-10-thione or -10-sulfide (DOPS-OH)

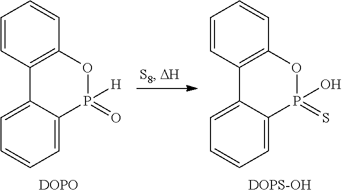

9,10-Dihydro-9-oxa-10-phosphaphenanthrene-10-one or -10-oxide (DOPO) was purchased from Schill+Seilacher AG, Boeblingen, Germany. 240 g (1.11 mol) of DOPO and 96 g (3.0 mol) of elemental sulfur were thoroughly mixed, the mixture was introduced into a round-bottomed flask, and air was displaced with an inert gas (argon or nitrogen). Then, the flask containing the solid starting materials was heated in a heating bath preset at 135° C. After 15 min, the heating bath was removed. The resulting yellow melt was poured into a steel container. After the mixture had cooled down, the resulting solid was mechanically comminuted and heated together with 500 mL of methanol. Then, excessive sulfur was filtered off, and the methanol was distilled off on a rotary evaporator under partial vacuum, resulting in a light-yellow crude product, which was recrystallized from 700 mL of toluene. The toluene was removed in vacuo, which yielded 248.1 g (90% of theory) of DOPS-OH in the form of white crystals.

Mp.: 149-151° C. (toluene)

³¹P-NMR (CDCl₃): 72.2 ppm

MS: 248 (C₁₂H₉O₂PS)

Elemental analysis: calcd. P 12.49%. Found P 12.28%

### Example 3

### Preparation of 9,10-dihydro-10-hydroxy-9-oxa-10-phosphaphenanthrene-10-thione or -10-sulfide ammonium salt (DOPS-ONH₄)

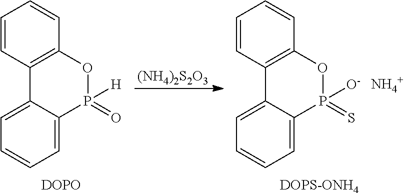

21.6 g (0.10 mol) of DOPO and 14.8 g (0.10 mol) of ammonium thiosulfate were thoroughly mixed, and the mixture was transferred to a round-bottomed flask. Then, the flask containing the solid starting materials was heated in a heating bath preset at 160° C. After 30 min, the heating bath was removed, and the reaction mixture was allowed to cool down. Then, 250 mL of ethanol were added, and the mixture was heated to boiling. Subsequently, the undissolved solid was filtered off, and the filtrate was evaporated in vacuo. The residue (approx. 20 g) consisting of 85% of DOPS-ONH₄ was recrystallized from acetonitrile to yield 19.1 g (75% of theory) of DOPS-ONH₄ in the form of white crystals.

Mp.: 238-239° C. (dec.) (acetonitrile)

³¹P-NMR (CDCl₃/ethanol): 60.1 ppm

MS: 248 (analogous to DOPS-OH)

Elemental analysis: calcd. P 11.69%. Found P 11.43%

### Example 4

### Preparation of 9,10-dihydro-10-hydroxy-9-oxa-10-phosphaphenanthrene-10-thione or -10-sulfide ammonium salt (DOPS-ONH₄)

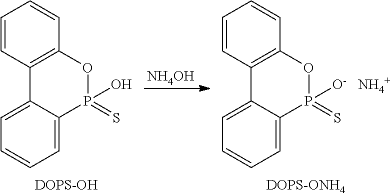

12.4 g (0.05 mol) of DOPS-OH were dissolved in 50 mL of ethanol under gentle warming. After cooling, 8 mL of 25% ammonia solution were added. The solution was allowed to rest at room temperature for 1 h, whereafter ethanol was removed in vacuo. The residue was recrystallized from acetonitrile to yield 11.5 g (90% of theory) of DOPS-ONH₄ in the form of white crystals. The product thus obtained was chemically identical to that of Example 3.

### Example 5

### Preparation of 9,10-dihydro-10-mercapto-9-oxa-10-phosphaphenanthrene-10-thione or -10-sulfide (DOPS-SH)

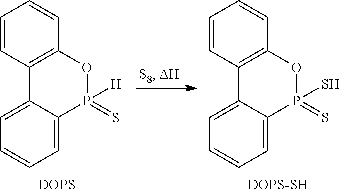

11.6 g (0.05 mol) of DOPS and 1.6 g (0.05 mol) of elemental sulfur were thoroughly mixed, the mixture was transferred to a round-bottomed flask, and air was displaced with an inert gas (nitrogen). Then, the solid starting materials were heated in a heating bath preset at 130° C. After 15 min, the heating bath was removed. The resulting light-yellow melt was poured out and allowed to cool down and solidify to give an amorphous solid containing 93% of DOPS-SH in admixture with DOPS starting material according to NMR analysis.

³¹P-NMR (CDCl₃): 78.7 ppm

MS: 264 (C₁₂H₉OPS₂)

### Example 6

### Preparation of bis(9,10-dihydro-9-oxa-10-oxo-10-phosphaphenanthrene-10-yl)-sulfide (DOPO-S-DOPO) and 9,10-dihydro-10-(9,10-dihydro-9-oxa-10-phospha-10-thioxophenanthrene-10-ylthio)-9-oxa-10-phosphaphenanthrene-10-one or -10-oxide (DOPS-S-DOPO)

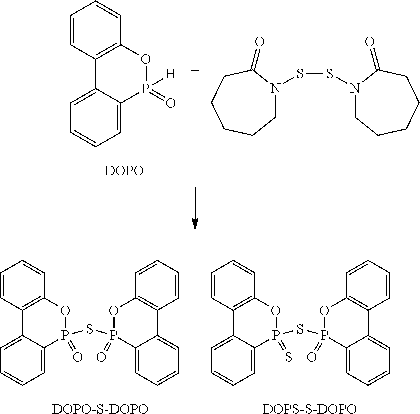

30 g (0.139 mol) of DOPO, 20 g (0.69 mol) of N,N′-dicaprolactam disulfide (bis-(hexahydro-2-oxo-2H-azepine-1-yl)disulfide) and 120 mL of toluene were stirred at reflux temperature under exclusion of air for 3 h in a round-bottomed flask equipped with a condenser, a mechanical agitator, and an inert gas inlet tube. After cooling, the dark supernatant was removed by decanting. The residue was boiled with 100 mL of acetonitrile, and the hot solution was filtered through a fluted filter. During cooling, a granular solid separated, which was filtered off and dried in vacuo. This yielded 19.8 g of a gray powder, which contained a 37:63 mixture of the compounds DOPO-S-DOPO and DOPS-S-DOPO according to NMR analysis. ³¹P-NMR (CDCl₃): DOPO-S-DOPO: 0.61 ppm

DOPS-S-DOPO: 0.14 ppm, 0.61 ppm, 63.4 ppm, 63.7 ppm

MS: DOPO-S-DOPO: 462 (C₂₄H₁₆O₄P₂S)
DOPS-S-DOPO: 478 (C₂₄H₁₆O₃P₂S₂)

Elemental analysis (37% DOPO-S-DOPO, 63% DOPS-S-DOPO):

calcd. P 13.13%. Found P 13.40%

### Example 7

### Preparation of 9,10-dihydro-10-mercapto-9-oxa-10-phosphaphenanthrene-10-thione or -10-sulfide triethylammonium salt (DOPS-SNH(Et)₃)

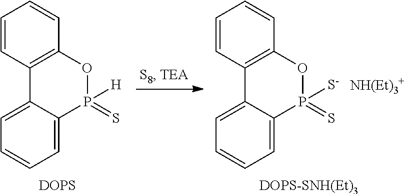

9.3 g (0.04 mol) of DOPS and 1.31 g (0.041 mol) of sulfur were stirred in 100 mL of abs. toluene for 1.5 h at 35° C. Then, 5.3 g (0.053 mol) of triethylamine were added dropwise with stirring, and the resulting suspension was stirred for 1 h at approx. 50° C. After cooling to room temperature, the precipitated solid was filtered off, washed with diethyl ether, and dried under gentle warming in vacuo. This yielded 13.4 g (92% of theory) of DOPS-SNH(Et)₃ as a white crystalline solid.

Mp.: 137-139° C.

³¹P-NMR (CDCl₃): 99.8 ppm

Elemental analysis: calcd. P 8.47%. Found P 8.32%

### Example 8

### Preparation of 9,10-dihydro-10-mercapto-9-oxa-10-phosphaphenanthrene-10-thione or -10-sulfide triethylammonium salt (DOPS-SNH(Et)₃)

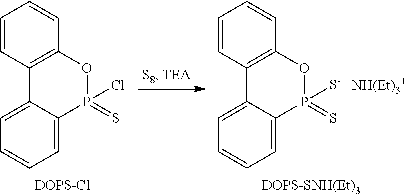

26.6 g of DOPS-Cl (0.1 mol) were dissolved in 75 mL of dry toluene at 80° C., followed by the addition of 34 g (0.33 mol) of triethylamine and then 7 g (0.22 mol) of elemental sulfur. The reaction mixture was stirred under inert gas atmosphere for 6 h at 90° C., then the temperature was increased to 100° C. and stirring was continued for further 5 h. In the course of the reaction, the color of the flask content turned dark, and a viscous sediment developed, which solidified during subsequent cooling to give a solid. The solid was sucked off using a glass frit, washed three times with toluene, and dried. The solid was stirred at room temperature for 5 min in 200 mL of ethanol to remove triethylamine hydrochloride, sucked off, suspended in 100 mL of toluene, and stirred at 60° C. for 30 min to remove the dark impurities. Then, the product was sucked off, washed with diethyl ether, and dried in vacuo. The yield was 29.6 g of DOPS-SNH(Et)₃ as a slightly brown powder (80% of theory), which was chemically identical to the product of Example 7.

### Example 9

### Preparation of 9,10-dihydro-10-hydroxy-9-oxa-10-phosphaphenanthrene-10-thione or -10-sulfid-triethylammonium salt (DOPS-ONH(Et)₃)

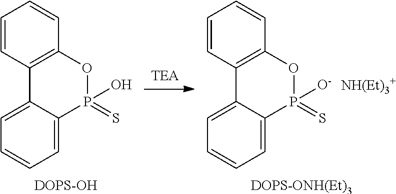

To a suspension of 12.41 g (0.05 mol) of DOPS-OH in 75 ml abs. toluene, 6 g (0.06 mol) of triethylamine were added dropwise with stirring within 15 min at 60° C. The reaction mixture was stirred for further 30 min and then cooled. The resulting solid was filtered off using a glass frit, washed with ether, and dried under gentle warming in vacuo. This yielded 13.4 g (99% of theory) of DOPS-OH(Et)₃ as a white crystalline solid.

Mp.: 147-148.5° C.

³¹P-NMR (CDCl₃): 61.3 ppm

Elemental analysis: calcd. P 8.86%. Found P 8.78%

### Example 10

### Preparation of 9,10-dihydro-10-hydroxy-9-oxa-10-phosphaphenanthrene-10-thione or -10-sulfide melaminium salt (DOPS-OMel)

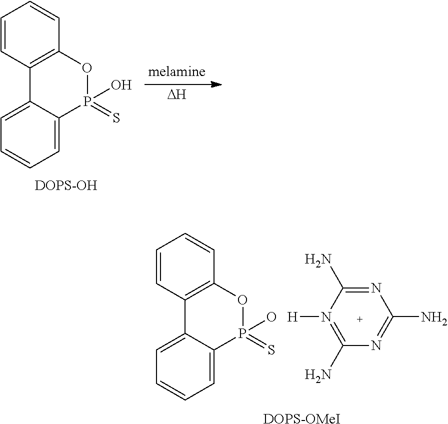

While flushing with an inert gas, 126.1 g (1.0 mol) of finely ground melamine were filled into 1300 ml of water at room temperature in a round-bottomed flask equipped with a condenser. While vigorously stirring this suspension, 248.2 g (1.0 mol) of DOPS-OH were added. The reaction mixture was heated at 90° C., and stirring was continued for further 4 h at the same temperature. Cooling to room temperature gave a stirrable slurry which was filtered, and the filter cake was dried in air at 70° C. to a residual moisture <0.1% (Karl Fischer) and then ground, which gave 365.7 g (98% of theory) of DOPS-OMel as a fine-crystalline white solid.

Mp.: 275° C. (dec.) (H₂O)

³¹P-NMR (MeOH-d₄): 60.7 ppm

Elemental analysis: calcd. P 8.27%, N 22.44%. Found P 8.19%, N 22.42

### Example 11

### Preparation of 9,10-dihydro-10-hydroxy-9-oxa-10-phosphaphenanthrene-10-thione or -10-sulfide guanidinium salt (DOPS-OGua)

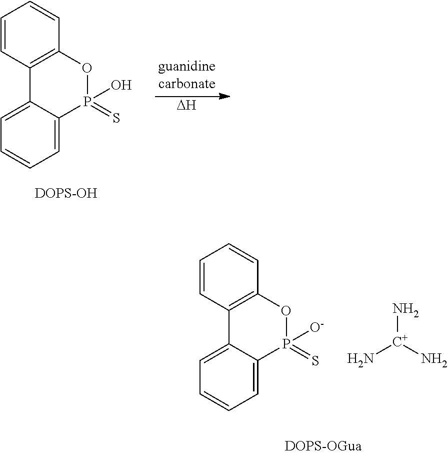

While flushing with an inert gas, 90.1 g (0.5 mol) of guanidine carbonate were dissolved in 300 g of water in a round-bottomed flask equipped with a mechanical agitator and a condenser. While vigorously stirring this solution, 248.2 g (1.0 mol) of DOPS-OH were added in portions and with avoidance of strong gas formation. The obtained suspension was first heated at 140° C. under normal pressure, and after termination of steam formation heated at 185° C. under water-jet vacuum to remove the water. After the obtained water-free melt had been poured out, cooled and ground, 304.5 g (99% of theory) of DOPS-OGua were obtained as an amber powder.

Mp.: 173-179° C. (H₂O)

³¹P-NMR (acetone-d₆): 57.9 ppm

Elemental analysis: calcd. P 10.07%, N 13.67%. Found P 10.27%, N 13.69

### Example 12

### Preparation of bis(9,10-dihydro-9-oxa-10-phospha-10-thioxophenanthrene-10-yl)-sulfide (DOPS-S-DOPS)

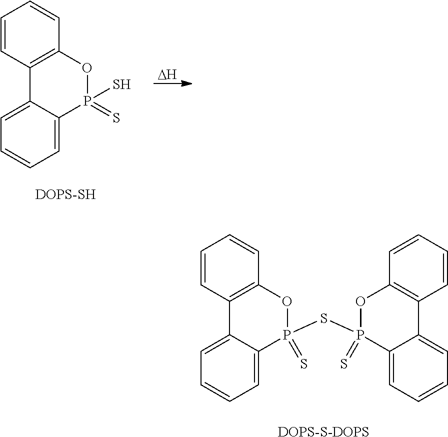

13.21 g (0.05 mol) of DOPS-SH were stirred at reflux in 120 mL of acetonitrile for 2 h, resulting in a granular solid that was filtered off and then stirred at reflux for 1 h in xylene. The solid was filtered off, washed with warm chloroform and then diethyl ether, and dried in vacuo. This yielded 7.7 g (78% of theory) of DOPS-S-DOPS as a white crystalline solid.

Mp.: 237-239° C. (xylene)

³¹P-NMR (CDCl₃): 74.1 ppm; 74.8 ppm

MS: 494 (C₂₄H₁₆O₂P₂S₃)

Elemental analysis: calcd. P 12.53%. Found P 12.41%

### Example 13

### Preparation of bis(9,10-dihydro-9-oxa-10-phospha-10-thioxophenanthrene-10-yl)-disulfide (DOPS-S₂-DOPS)

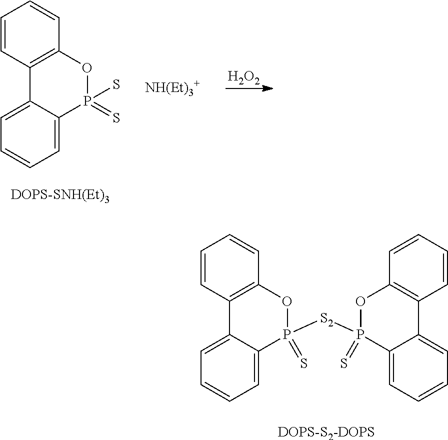

To a suspension of 5.48 g (0.015 mol) of DOPS-ONH(Et)₃ in 50 ml abs. toluene, 0.66 g (0.018 mol) of 37% hydrochloric acid were added with a syringe at approx. 20° C., followed by the dropwise addition of 5.6 g (0.016 mol) of a 10% solution of hydrogen peroxide in ethyl acetate within 10 min under vigorous stirring. After further 30 min, 0.75 mL of triethylamine were added to neutralize excessive hydrochloric acid, then the volatile components were distilled off in vacuo. The residue was stirred with a mixture of 75 mL of water and 25 mL of ethanol for about 15 min under gentle warming to dissolve triethylamine hydrochloride. Then, the solid was sucked off and stirred again in water/ethanol. The white powder obtained after repeated sucking-off and drying under gentle warming in vacuo was recrystallized from acetonitrile, which yielded 3.20 g (81% of theory) of DOPS-S₂-DOPS.

Mp.: 126-130° C. (dec.) (acetonitrile)

³¹P-NMR (CDCl₃): 84.28 ppm; 84.65 ppm

MS: 526 (C₂₄H₁₆O₂P₂S₄)

Elemental analysis: calcd. P 11.76%. Found P 11.62%

### Example 14

### Preparation of bis(9,10-dihydro-9-oxa-10-phospha-10-thioxophenanthrene-10-yl)-tetrasulfide (DOPS-S₄-DOPS)

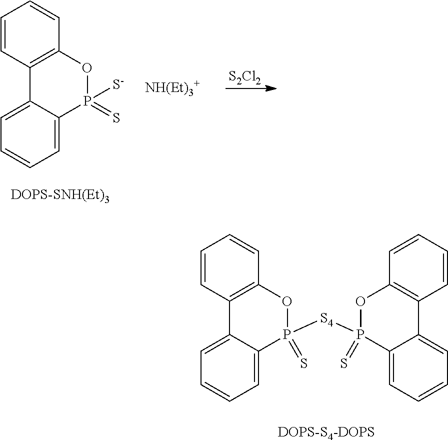

To a suspension of 2.75 g (0.0075 mol) of DOPS-ONH(Et)₃ in 50 ml abs. toluene, 0.51 g (0.00375 mol) of disulfur dichloride were added within 5 min at approx. 20° C. using a syringe. After completion of the addition, the reaction mixture was stirred at room temperature for 2 h, then the volatile components were distilled off in vacuo. The residue was stirred with a mixture of 50 mL of water and 10 mL of ethanol for approx. 30 min at 35° C. to dissolve triethylamine hydrochloride. Then, the solid was sucked off and again stirred in a mixture of 30 mL of water and 20 mL of ethanol. After filtering, the solid was recrystallized from acetonitrile and then dried under gentle warming in vacuo, which yielded 1.9 g (86% of theory) of DOPS-S₄-DOPS as a white solid.

Mp.: from approx. 150° C. (dec.) (acetonitrile)

³¹P-NMR (CDCl₃): 84.0 ppm; 84.5 ppm

MS: 590 (C₂₄H₁₆O₂P₂S₆)

Elemental analysis: calcd. P 10.49%. Found P 10.56%

### Example 15

### Preparation of di(9,10-dihydro-9-oxa-10-phospha-10-thioxophenanthrene-10-yl)-ether (DOPS-O-DOPS)

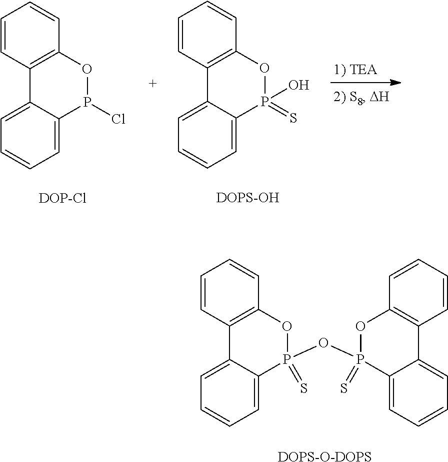

### 1) Dimerization

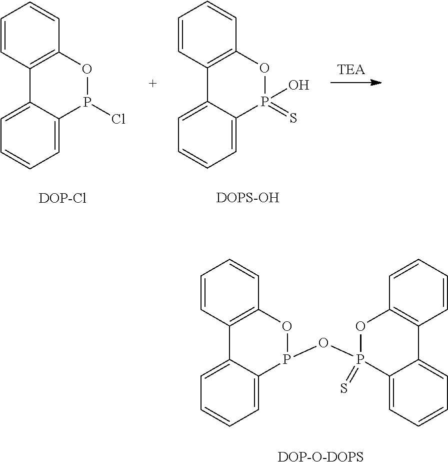

While flushing with an inert gas, 23.5 g (0.10 mol) of DOP-Cl were introduced into a round-bottomed flask equipped with a thermometer, a mechanical agitator, and a condenser, followed by the addition of 130 mL of toluene free of air and moisture, and the mixture was heated at 60° C. After complete dissolution of the DOP-Cl, 12.3 g (0.12 mol) of triethylamine were added. Then, 24.8 g (0.1 mol) of DOPS-OH were added within 15 min. After further 6 h at 60° C., the heater and the agitator were turned off, and the reaction was allowed to rest at room temperature for 12 h.

### 2) Sulfidation

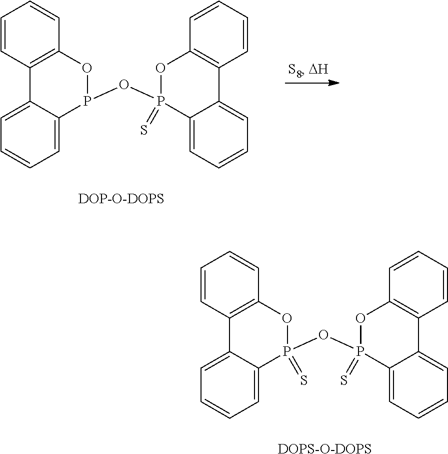

Then, 3.2 g (0.1 mol) of sulfur were added, and the suspension was heated at 80° C. After 1.5 h, the temperature was raised to 100° C., and 4 h later the heater and the agitator were turned off. After cooling, the precipitated solid was filtered off, suspended in water to remove the triethylammonium chloride, and again filtered. This washing procedure was repeated. Then, the still brownish solid was washed with chloroform and dried in vacuo. The yield was DOPS-O-DOPS as a white solid (43 g, i.e. 90% of theory).

Mp.: 210-215° C.

³¹P-NMR (CDCl₃): 62.3 ppm; 62.8 ppm

MS: 478 (C₂₄H₁₆O₃P₂S₂)

Elemental analysis: calcd. P 12.95%. Found P 12.61%

### Example 16

### Preparation of 9,10-dihydro-10-(9,10-dihydro-9-oxa-10-phospha-10-thioxophenanthrene-10-yloxy)-9-oxa-10-phosphaphenanthrene-10-one or -10-oxide (DOPS-O-DOPO)

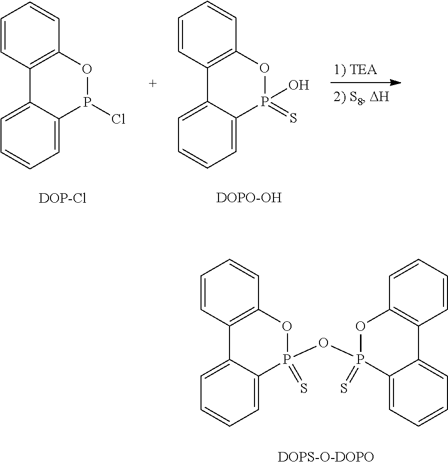

### 1) Dimerization

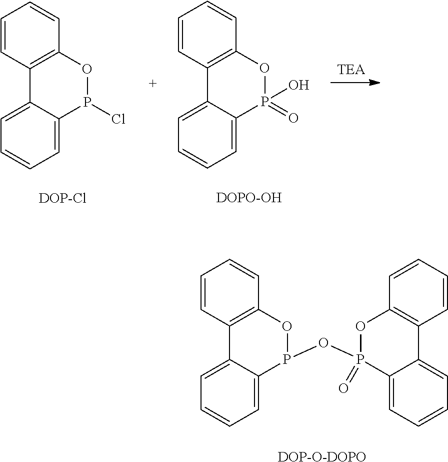

While flushing with an inert gas, 22.7 g (0.097 mol) of DOP-Cl were introduced into a round-bottomed flask equipped with a thermometer, a mechanical agitator, and a condenser, followed by the addition of 100 mL of toluene free of air and moisture, and the mixture was heated at 60° C. After complete dissolution of the DOP-Cl, 10.0 g (0.10 mol) of triethylamine were added. Then, 22.5 g (0.097 mol) of DOPS-OH were added within 10 min, and the reaction mixture was stirred for 3 h at 60° C.

### 2) Sulfidation

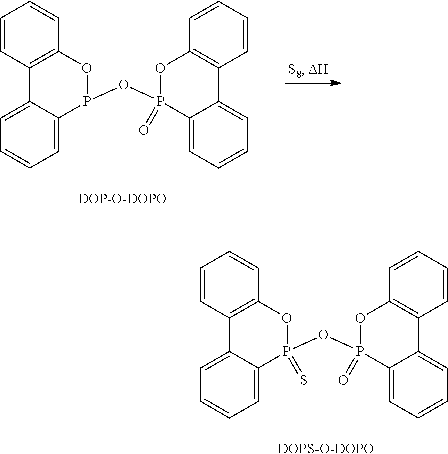

Then, 3.2 g (0.10 mol) of elemental sulfur were added, and the reaction mixture was stirred for 6 h at 95° C., then the heater and the agitator were turned off. After cooling, the precipitated solid was filtered off, suspended in water to remove the triethylammonium chloride, and again filtered. This washing procedure was repeated. Then, the solid was dried in vacuo. The yield was DOPS-O-DOPO as a white solid (39 g, i.e. 87% of theory).

Mp.: 211-216° C.

³¹P-NMR (CDCl₃): −0.61 ppm; −0.29 ppm; −0.03 ppm. 0.30 ppm;
63.26 ppm; 63.45 ppm; 63.58 ppm; 63.79 ppm

MS: 462 (C₂₄H₁₆O₄P₂S)

Elemental analysis: calcd. P 13.40%. Found P 13.45%

### Example 17

### Preparation of bis(9,10-dihydro-9-oxa-10-phospha-10-thioxophenanthrene-10-yl)-sulfide (DOPS-S-DOPS)

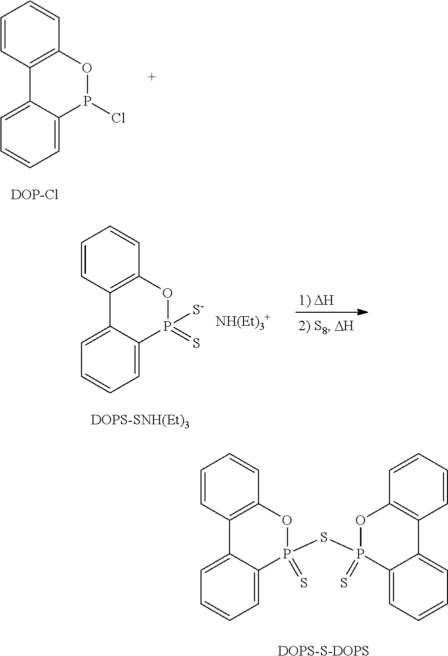

### 1) Dimerization

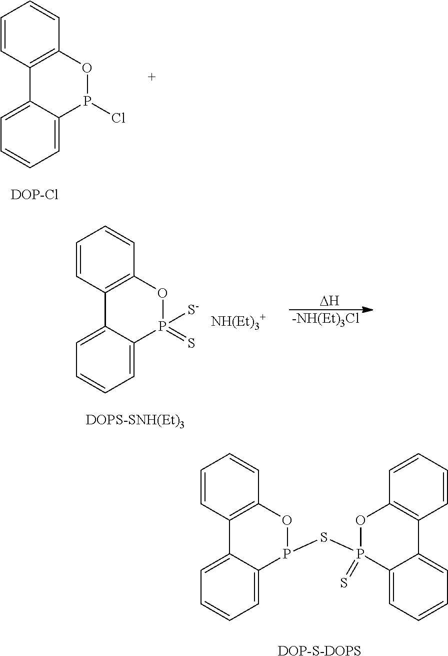

While flushing with an inert gas, 4.7 g (0.02 mol) of DOP-Cl were introduced into a round-bottomed flask equipped with a thermometer, a mechanical agitator and a condenser, followed by the addition of 60 mL of toluene free of air and moisture, and the mixture was heated at 60° C. After complete dissolution of the DOP-Cl, 7.3 g (0.02 mol) of DOPS-SNH(Et)₃ were added with stirring, and the reaction mixture was stirred for 4 h at 60° C. The resulting suspension was filtered without previous cooling under exclusion of moisture to separate the triethylammonium chloride. The filter cake was washed again with warm abs. toluene, the filtrates were combined and concentrated in vacuo to approx. 50 mL.

### 2) Sulfidation

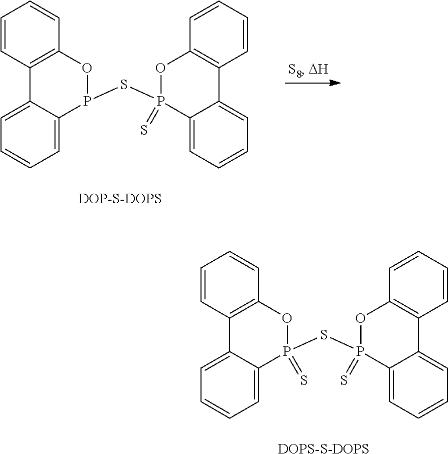

To the concentrated solution of DOP-S-DOPS, 0.64 g (0.02 mol) of elemental sulfur were added, then the reaction mixture was stirred at 100° C. for 4 h in an inert gas atmosphere. After cooling, the precipitated solid was filtered off, washed with warm abs. toluene, and dried in vacuo. This yielded DOPS-S-DOPS as a light gray powder (5.1 g, i.e. 52% of theory). The product thus obtained was chemically identical to that of Example 12.

### Example 18

### Preparation of 9,10-dihydro-10-mercapto-9-oxa-10-phosphaphenanthrene-10-thione or -10-sulfide (DOPS-SH)

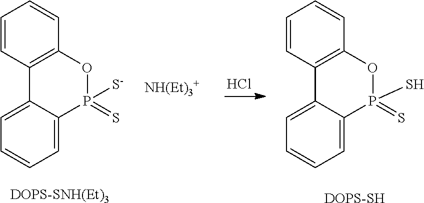

9.13 g (0.025 mol) of DOPS-SNH(Et)₃ were dissolved at 60° C. in an inert gas atmosphere in 100 mL of ethanol. After cooling, 50 mL of conc. hydrochloric acid, 200 mL of water, and approx. 20 g of NaCl were added, followed by the addition of 150 mL of toluene. The mixture was stirred for 10 min and then transferred to a separating funnel. The toluene layer was separated, and the aqueous layer was extracted three times with 30 mL of toluene each. The organic layers were combined, washed with 50 mL of water, and dried over Na₂SO₄. After the drying agent had been filtered off and the toluene had been distilled off in vacuo, DOPS-SH was obtained with a yield of 85% as a crystalline solid.

³¹P-NMR (CDCl₃): 78.7 ppm

MS: 264 (C₁₂H₉OPS₂)

Elemental analysis: calcd. P 11.72%. Found P 11.29%

### Example 19

In-situ preparation of 9,10-dihydro-10-hydroxy-9-oxa-10-phosphaphenanthrene-10-thione or -10-sulfide (DOPS-OH) during provision of plastics with flame retardancy

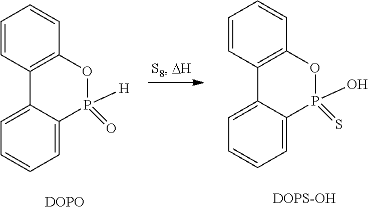

The reaction mechanism was analogous to Example 2. Granular polystyrene (M_{w}: approx. 192,000 g/mol, T_{g}: approx. 94° C.) was processed to give a uniform strand together with 5 wt % of DOPO and 2 wt % of sulfur at 175-180° C. with a dwelling time of 3 min in a twin-screw extruder of the trademark Prism Eurolab 16 from Thermo Scientific by using a nozzle with an exit slit of 16×4 mm. ³¹P NMR analysis showed that DOPO had converted practically quantitatively to DOPS-OH.

These examples enable an artisan to produce the desired flame retardants as well as any starting products required.

### Preparation of Expandable Polymerizates Containing Such Flame Retardants:

Generally, it should be mentioned that the preparation of flameproof expandable polymerizates, e.g. of EPS, in the form of granules or beads is generally known to the artisan, and the production of the inventive polymerizates containing the above flame retardants works in an essentially analogous way. For example, the examplary embodiments of WO 2006/027241 may be used, wherein instead of the phosphorus compounds used therein, the flame retardants mentioned in the present invention are used. The same is true for the polymeric foam or XPS.

Below, the present invention is described in a detailed and reproducible manner by means of specific examples of the invention that should not be considered as a limitation. Below, these examples are also used for demonstrating their effectiveness.

### a) First Experimental Series

### 6 Examples

Example 4 is a comparative example with the well-known flame retardant DOPO for Table 4 below.

### Example 1

### Example of the Invention—5% of DOPS-OH

To a styrene polymer (SUNPOR EPS-STD: 6 wt % of pentane, chain length Mw=200,000 g/mol, non-uniformity Mw/Mn=2.5) in the feed area of a twin-screw extruder, 5 wt % of 6-hydroxy-6H-dibenz[c,e][1,2]-oxaphosphorine-6-sulfide (hydroxy-DOPS), based on the granular EPS obtained, were added and molten in the extruder at 190° C. The polymer melt thus obtained was conveyed through a nozzle plate with a flow rate of 20 kg/h and granulated with a pressurized under-water granulator to give compact granular EPS.

### Example 2

### Example of the Invention—10% of DOPS-OH

Example 1 was repeated, with the difference that 10 wt % of 6-hydroxy-6H-dibenz-[c,e][1,2]oxaphosphorine-6-sulfide (hydroxy-DOPS), based on the granular EPS obtained, were added.

### Example 3

### Example of the Invention—Additional HBCD

Example 1 was repeated, with the difference that additionally 0.1 wt % of hexabromocyclododecane (HBCD), based on the granular EPS obtained, were added.

### Example 4

### Comparative Example—10% of DOPO

To a styrene polymer (SUNPOR EPS-STD: 6 wt % of pentane, chain length Mw=200,000 g/mol, non-uniformity MW/Mn=2.5) in the feed area of a twin-screw extruder, 10 wt % of 9,10-dihydro-9-oxa-10-phospha-phenanthrene-10-oxide (DOPO), based on the granular EPS obtained, were added and molten in the extruder at 190° C. The polymer melt thus obtained was conveyed through a nozzle plate with a flow rate of 20 kg/h and granulated with a pressurized under-water granulator to give compact granular EPS.

### Example 5

### Example of the Invention—Additional Additives

Example 1 was repeated, with the difference that additionally 0.2 wt % of dicumyl peroxide (DCP) and 0.2 wt % of 4-hydroxy-2,2,6,6-tetramethylpiperidino-N-oxide (HTEMPO), based on the granular EPS obtained, were added.

### Example 6

### Example of the Invention—10% of DOPS-OH, Alternative Preparation+Additives

4 kg of styrene were added to a pressure reactor equipped with an agitator, a heater, and a cooler, and 10 wt % of 6-hydroxy-6H-dibenz[c,e][1,2]oxaphosphorine-6-sulfide (hydroxy-DOPS), based on the EPS beads obtained, were dissolved. Then, 10 g of dibenzoyl peroxide (75% in water), 8 g of tert-butylperoxy-2-ethyl-hexylcarbonate and 10 g of dicumyl peroxide were added. To this preparation, 20 L of demineralized water containing 14 g of sodium pyrophosphate and 26 g of magnesium sulfate were added and kept at 90° C. for 5 hours under continuous stirring. The reactor was sealed and, after the addition of 7% of pentane, based on styrene, heated to 125° C. and kept at this temperature for 2.5 hours. The EPS beads obtained had an average grain size of 1 mm.

### b) Second Experimental Series

### 20 Examples

### Comparative Examples

### Example 1

### Comparative Example—10% of DOPO

To a styrene polymer (SUNPOR EPS-STD: 6 wt % of pentane, chain length Mw=200,000 g/mol, non-uniformity Mw/Mn=2.5) in the feed area of a twin-screw extruder, 10 wt % of 9,10-dihydro-9-oxa-10-phospha-phenanthrene-10-oxide (DOPO), based on the granular EPS obtained, were added and molten in the extruder at 190° C. The polymer melt thus obtained was conveyed through a nozzle plate with a flow rate of 20 kg/h and granulated with a pressurized underwater granulator to give compact granular EPS.

### Example 2

### Comparative Example—15% of DOPO

Example 1 was repeated, with the difference that 15 wt % of 9,10-dihydro-9-oxa-10-phospha-phenanthrene-10-oxide (DOPO), based on the granular EPS obtained, were added.

### Example 3

### Comparative Example—5% of Sulfur

Example 1 was repeated, with the difference that only 5 wt % of yellow sulfur, based on the granular EPS obtained, were added.

### Examples of the Invention

### Example 4

### Example of the Invention—10% of DOPS-SNH(Et)₃

To a styrene polymer (SUNPOR EPS-STD: 6 wt % of pentane, chain length Mw=200,000 g/mol, non-uniformity Mw/Mn=2.5) in the feed area of a twin-screw extruder, 10 wt % of 9,10-dihydro-10-mercapto-9-oxa-10-phosphaphenanthrene-10-thione or -10-sulfide triethylammonium salt (DOPS-SNH(Et)₃), based on the granular EPS obtained, were added and molten in the extruder at 190° C. The polymer melt thus obtained was conveyed through a nozzle plate with a flow rate of 20 kg/h and granulated with a pressurized underwater granulator to give compact granular EPS.

The following examples of the invention were prepared in an analogous way to or at the same conditions as in Examples 1 to 4, but with different flame retardants or synergists. The wt % values refer to the granular EPS obtained:

### Example 5

### Example of the Invention—10% of DOPS-SNH(Et)₃+2% of Sulfur

10 wt % of 9,10-Dihydro-10-mercapto-9-oxa-10-phosphaphenanthrene-10-thione or -10-sulfide triethylammonium salt (DOPS-SNH(Et)₃) and 2 wt % of yellow sulfur.

### Example 6

### Example of the Invention—10% of DOPS-ONH(Et)₃

10 wt % of 9,10-dihydro-10-hydroxy-9-oxa-10-phosphaphenanthrene-10-thione or -10-sulfide triethylammonium salt (DOPS-ONH(Et)₃).

### Example 7

### Example of the Invention—10% of DOPS-ONH(Et)₃+2% of Sulfur

10 wt % of 9,10-dihydro-10-hydroxy-9-oxa-10-phosphaphenanthrene-10-thione or -10-sulfide triethylammonium salt (DOPS-ONH(Et)₃) and 2 wt % of yellow sulfur.

### Example 8

### Example of the Invention—7.5% of DOPS-OMel+2% of Sulfur

7.5 wt % of 9,10-dihydro-10-hydroxy-9-oxa-10-phosphaphenanthrene-10-thione or -10-sulfide melaminium salt (DOPS-OMel) and 2 wt % of yellow sulfur.

### Example 9

### Example of the Invention—7.5% of DOPS-OMel+5% of BBDS

7.5 wt % of 9,10-dihydro-10-hydroxy-9-oxa-10-phosphaphenanthrene-10-thione or -10-sulfide melaminium salt (DOPS-OMel) and 5 wt % of bis(benzothiazolyl)-disulfide (BBDS).

### Example 10

### Example of the Invention—7.5% of DOPS-OGua+2% of Sulfur

7.5 wt % of 9,10-dihydro-10-hydroxy-9-oxa-10-phosphaphenanthrene-10-thione or -10-sulfide guanidinium salt (DOPS-OGua) and 2 wt % of yellow sulfur.

### Example 11

### Example of the Invention—7.5% of DOPS-OGua+5% of BBDS

7.5 wt % of 9,10-dihydro-10-hydroxy-9-oxa-10-phosphaphenanthrene-10-thione or -10-sulfide guanidinium salt (DOPS-OGua) and 5 wt % of bis(benzothiazolyl)-disulfide (BBDS).

### Example 12

### Example of the Invention—7.5% of DOPS-S-DOPS+2% of Sulfur

7.5 wt % of bis(9,10-dihydro-9-oxa-10-phospha-10-thioxophenanthrene-10-yl)-sulfide (DOPS-S-DOPS) and 2 wt % of yellow sulfur.

### Example 13

### Example of the Invention—7.5% of DOPS-S-DOPS+5% of DCDS

7.5 wt % of bis(9,10-dihydro-9-oxa-10-phospha-10-thioxophenanthrene-10-yl)-sulfide (DOPS-S-DOPS) and 5 wt % of N,N′-dicaprolactam disulfide (DCDS).

### Example 14

### Example of the Invention—7.5% of DOPS-S-DOPS+5% of BBDS

7.5 wt % of bis(9,10-dihydro-9-oxa-10-phospha-10-thioxophenanthrene-10-yl)-sulfide (DOPS-S-DOPS) and 5 wt % of bis(benzothiazolyl)disulfide (BBDS).

### Example 15

### Example of the Invention—10% of DOPS-S₂-DOPS

10 wt % of bis(9,10-dihydro-9-oxa-10-phospha-10-thioxophenanthrene-10-yl)-disulfide (DOPS-S₂-DOPS).

### Example 16

### Example of the Invention—7.5% of DOPS-S₂-DOPS+2% of Sulfur

7.5 M % of bis(9,10-dihydro-9-oxa-10-phospha-10-thioxophenanthrene-10-yl)-disulfide (DOPS-S₂-DOPS) and 2 wt % of yellow sulfur.

### Example 17

### Example of the Invention—10% of DOPS-S₄-DOPS

10 wt % of bis(9,10-dihydro-9-oxa-10-phospha-10-thioxophenanthrene-10-yl)-tetrasulfide (DOPS-S₄-DOPS).

### Example 18

### Example of the Invention—7.5% of DOPS-S₄-DOPS+2% of Sulfur

7.5 wt % of bis(9,10-dihydro-9-oxa-10-phospha-10-thioxophenanthrene-10-yl)-tetrasulfide (DOPS-S₄-DOPS) and 2 wt % of yellow sulfur.

### Example 19

### Example of the Invention—7.5% of DOPS-O-DOPS+2% of Sulfur

7.5 wt % of bis(9,10-dihydro-9-oxa-10-phospha-10-thioxophenanthrene-10-yl)oxide (DOPS-O-DOPS) and 2 wt % of yellow sulfur.

### Example 20

### Example of the Invention—7.5% of DOPO-O-DOPS+2% of Sulfur

7.5 wt % of DOPO-O-DOPS and 2 wt % of yellow sulfur.

These examples enable an artisan to produce the expandable polymerizates as well as the polymeric foams.

### Detection of the Effectiveness of the Flame Retardants:

a) Effectiveness in Compact Polystyrene:

Compact polystyrene already shows advantageous effects of the above flame retardants:

Specimens were formed from granular polystyrene (M_{w}: approx. 192,000 g/mol, T_{g}: approx. 94° C.) as follows: The granulate was pulverized and mixed with the respective additives in a mortar. 12 g each of the solids mixtures were weighed into aluminum crucibles, which were then placed in a preheated drying cabinet and kept therein at the respectively required temperature until the powder had molten to give compact sheets. The required temperature depends on the composition of the respective mixture, and with the specimens tested it was between 165 and 195° C., and the melting process was completed after 10 to 20 min, as is shown in the following table. After cooling, the sheets were taken from the aluminum crucibles and sawed up for the flame-retardancy tests.

On the one hand, specimens of 70×13×4 mm were produced for examining the afterflame time (in s) in a flame treatment according to UL94.

UL94 is a testing standard of Underwriters Laboratories, the content of which was taken over into IEC/DIN EN 60695-11-10 and -20. Pilot flames act upon a specimen with a power of 50 W twice for a short period, wherein in vertical testing, the burning time and the falling of burning parts are evaluated by means of a cotton swab placed below the specimen. The classification comprises the steps “V0”, “V1” and “V2” described in the following Table 1:

TABLE 1
UL94 Classification

| Classification | V0 | V1 | V2 |
|---|---|---|---|
| Afterflame time after each flame treatment | ≦10 s | ≦30 s | ≦30 s |
| Overall burning time for each set | ≦50 s | ≦250 s | ≦250 s |
| (10 flame treatments) | | | |
| Afterflame time/afterglowing after 2^{nd} treatment | ≦30 s | ≦60 s | ≦60 s |
| Burning off to holding chamber | no | no | no |
| Inflammation of cotton | no | no | yes |

The classification of “V0” thus represents the highest requirements in fire protection and is consequently to be aimed for in the use of flame-retardant compositions.

On the other hand, specimens of 120×10×4 mm were manufactured and examined according to ISO 4589 to determine the oxygen index (LOI, “Limiting Oxygen Index”) thereof. This is the minimum oxygen concentration (in admixture with nitrogen) at which burning of a specimen can still be maintained. Here, a vertically positioned specimen is inflamed in a glass cylinder flushed with the respective oxygen/nitrogen mixture by means of a propane gas flame, and the fire behavior thereof is monitored. Shorter burning times and higher LOI values consequently superior better fire protection.

The results of three test series of specimens are shown in the following tables, which are mean values of four measurements each.

TABLE 2
Test series 1 - Fire protection tests according to UL94 and
ISO 4589 for compact polystrene

| | Poly- | | | | Burning | |
|---|---|---|---|---|---|---|
| Exp. | styrene | Additive(s), | Processing | | time | LOI |
| No. | (wt %) | wt % | conditions | | (s) | (% O₂) |
| 1 | 100 | — | 180° | C. | not self- | 18.6 |
| | | | 15 min | | extinguishing | |
| 2 | 95 | comp.: DOPO, | 180° | C. | not self- | 20.5 |
| | | 5 | 12 min | | extinguishing | |
| 3 | 90 | comp.: DOPO, | 180° | C. | 24 | 20.8 |
| | | 10 | 12 min | | | |
| 4 | 95 | inv.: DOPS-OH, | 175° | C. | 24 | 22.6 |
| | | 5 | 15 min | | | |
| 5 | 94 | inv.: DOPS-OH, | 175° | C. | 2.2 | 25 |
| | | 5 sulfur, 1 | 15 min | | | |
| 6 | 93.5 | inv.: DOPS-OH, | 170-175° | C. | 2.0 | 25.5 |
| | | 5 sulfur, 1.5 | 15 min | | | |
| 7 | 92 | inv.: DOPS-OH, | 175° | C. | 1.6 | 25.2 |
| | | 5 sulfur, 3 | 15 min | | | |
| 8 | 93 | inv.: DOPS-OH, | 170-173° | C. | 12 | 23.0 |
| | | 7 | 12 min | | | |
| 9 | 90 | inv.: DOPS-OH, | 170-173° | C. | 4.0 | 23.4 |
| | | 10 | 12 min | | | |
| 10 | 95 | inv.: DOPS, 5 | 170-175° | C. | not self- | 21.0 |
| | | | 12 min | | extinguishing | |
| 11 | 94 | inv.: DOPS, 5 | 170-175° | C. | 1.2 | 24.3 |
| | | sulfur, 1 | 12 min | | | |
| 12 | 95 | inv.: DOPS-SH, | 170-174° | C. | 4.9 | 23.2 |
| | | 5 | 12 min | | | |
| 13 | 90 | inv.: DOPS-OH, | 160-163° | C | 6.3 | 23.5 |
| | | 5 DCDS, 5 | 10 min | | | |
| 14 | 88 | inv.: DOPS-OH, | 160-163° | C. | 1.6 | 24.3 |

| | |
|---|---|
| 7 DCDS, 5 | 10 min |

DCDS: N,N′-dicaprolactam disulfide

For comparison, LOI values of elemental sulfur as the only flame-retardant additive in polystyrene (molecular weight: 120,000 to 250,000 g/mol) are given. These values are taken from WO 99/10429:

Table 3: Fire protection test according to ISO 4589 with elemental sulfur

TABLE 3
Fire protection test according to ISO 4589 with elemental sulfur

| Experiment No. | Sulfur (wt %) | LOI (% O₂) |
|---|---|---|
| A-1 | 10.0 | 22.3 |
| A-2 | 3.0 | 22.2 |
| A-3 | 1.0 | 21.9 |
| A-4 | 0.44 | 20.7 |
| A-5 | 0.18 | 19.0 |

These results clearly show that the above compounds show a much better flame-retardant effect in compact polymers than the known DOPO additive, especially when used in combination with elemental sulfur or sulfur-containing compounds with which they show a synergistic effect, which may be seen in Table 2 and from a comparison of Tables 2 and 3, but is also shown by the fact that doubling the amount of sulfur in Experiment No. 7 as compared to Experiment No. 6 does not lead to any improvement of the fire protection effect. Furthermore, incorporating the inventive compounds into a resin mass is in most cases easier than incorporating DOPO.

In the following, the results of the fire protection test according to UL94 are shown for a second test series of novel compounds according to the present invention.

TABLE 4
Test series 2 - fire protection tests according to UL94

| | Poly- | | | | Burning |
|---|---|---|---|---|---|
| Exp. | styrene | Additive(s), | Processing | | time |
| No. | (wt %) | wt % | conditions | | (s) |
| 15 | 100 | — | 180° | C. | not self- |
| | | | 15 min | | extinguishing |
| 16 | 97 | comp.: sulfur, 3 | 180° | C. | not self- |
| | | | 12 min | | extinguishing |
| 17 | 95 | comp.: sulfur, 5 | 180° | C. | 40 |
| | | | 12 min | | |
| 18 | 95 | comp.: DOPO, 5 | 180° | C. | not self- |
| | | | 12 min | | extinguishing |
| 19 | 90 | comp.: DOPO, 10 | 180° | C. | 24 |
| | | | 12 min | | |
| 20 | 95 | comp.: BBDS, 5 | 180° | C. | 7.2 |
| | | | 15 min | | |
| 21 | 92.5 | comp.: DOPO, 5 | 180° | C. | 4.0 |
| | | BBDS, 2.5 | 14 min | | |
| 22 | 92.5 | inv.: DOPS-SNH(Et)₃, 7.5 | 175° | C. | 33 |
| | | | 14 min | | |
| 23 | 91 | inv.: DOPS-SNH(Et)₃, 7.5 | 175° | C. | 4.6 |
| | | sulfur, 1.5 | 15 min | | |
| 24 | 93 | inv.: DOPS-ONH(Et)₃, 7 | 175° | C. | 33 |
| | | | 13 min | | |
| 25 | 91.5 | inv.: DOPS-ONH(Et)₃, 7 | 180° | C. | 11 |
| | | sulfur, 1.5 | 14 min | | |
| 26 | 95.5 | inv.: DOPS-OMel, 2.5 | 190° | C. | 7.6 |
| | | sulfur, 2 | 15 min | | |
| 27 | 92 | inv.: DOPS-OMel, 3 | 190° | C. | 17.5 |
| | | BBDS, 5 | 15 min | | |
| 28 | 94.5 | inv.: DOPS-OGua, 3.5 | 190° | C. | 5.7 |
| | | sulfur, 2 | 15 min | | |
| 29 | 92 | inv.: DOPS-OGua, 3 | 190° | C. | 17.5 |
| | | BBDS, 5 | 15 min | | |
| 30 | 94 | inv.: DOPS-S-DOPS, 3.5 | 175-180° | C. | 1.9 |
| | | sulfur, 2.5 | 14 min | | |
| 31 | 91.5 | inv.: DOPS-S-DOPS, 3.5 | 170° | C. | 29 |
| | | DCDS, 5 | 12 min | | |
| 32 | 92.5 | inv.: DOPS-S-DOPS, 2.5 | 195° | C. | 2.0 |
| | | BBDS, 5 | 14 min | | |
| 33 | 94.3 | inv.: DOPS-S₂-DOPS, 5.7 | 173-176° | C. | 6.1 |
| | | | 14 min | | |
| 34 | 94 | inv.: DOPS-S₂-DOPS, 3.5 | 175° | C. | 17 |
| | | sulfur, 2.5 | 14 min | | |
| 35 | 94 | inv.: DOPS-S₄-DOPS, 6 | 175° | C. | 22 |
| | | | 14 min | | |
| 36 | 94.5 | inv.: DOPS-S₄-DOPS, 4 | 175° | C. | 19 |

| | |
|---|---|
| sulfur, 1.5 | 14 min |

DCDS: N,N′-dicaprolactam disulfide
BBDS: bis(benzothiazolyl)disulfide

The results in Table 4 also clearly show that the novel compounds have better flame-retardant effects than the known DOPO additive, especially when used in combination with elemental sulfur or sulfur-containing compounds.

Furthermore, the above table clearly shows that the synergy of the inventive compounds is substance-specific, i.e. not every sulfur-containing compound known to promote flame retardancy shows the same synergistic effect, if any. For example, melaminium or guanidinium salts of DOPS (Experiments 26 to 29) show substantially superior results with sulfur than with BBDS, although when used alone, BBDS has a better flame-retardant effect than the same weight amount of sulfur. The specific synergy is also proven by Experiments 30 to 32, wherein the dimer DOPS-S-DOPS shows excellent results with sulfur and BBDS as synergists, while with DCDS a generally average, compared to the other compositions of the invention a rather poor, performance is achieved.

The attempt to explain the occasionally excellent results of the dimer DOPS-S-DOPS by the presence of the double molar amount of phosphorus and even the triple amount of sulfur with equal weight proportions, is disproved by Experiments 33 to 36 with DOPS-S₂-DOPS and DOPS-S₄-DOPS. Even though increasingly more sulfur is contained in the same weight amounts of these compounds, the burning time values even deteriorate.

Below, the results of a fire protection test according to UL94 for a third test series of novel compounds according to the present invention by use of a further synergist are shown.

TABLE 5
Test series 3 - fire protection test according to UL94

| Exp. | Polystyrene | Additive(s), | Processing | Burning time |
|---|---|---|---|---|
| No. | (wt %) | wt % | conditions | (s) |
| 37 | 100 | — | 190° C. | not self- |
| | | | 15 min | extinguishing |
| 38 | 96 | comp.: Vultac TB7, 4 | 190° C. | 18 |
| | | | 15 min | |
| 39 | 93 | comp.: Vultac TB7, 7 | 190° C. | 11 |
| | | | 15 min | |
| 40 | 97 | inv.: DOPS-ONH₄, 3 | 190° C. | 23 |
| | | | 15 min | |
| 41 | 93 | inv.: DOPS-ONH₄, 3 | 190° C. | 5.2 |
| | | Vultac TB7, 4 | 15 min | |
| 42 | 93.5 | inv.: DOPS-O-DOPO, 2.5 | 190° C. | 6.7 |
| | | Vultac TB7, 4 | 15 min | |
| 43 | 93.5 | inv.: DOPS-O-DOPS, 2.5 | 190° C. | 3.2 |
| | | Vultac TB7, 4 | 15 min | |

Vultac TB7: p-tert-butylphenol disulfide polymer (polysulfide); a vulcanizing agent of Arkema Inc. (Philadelphia, PA, USA)

The results in Table 5 again prove the effectiveness of the inventive novel compounds as flame retardants, especially together with a sulfur-containing synergist. It is especially remarkable that Vultac TB7, a polysulfide vulcanization agent sold by Arkema Inc., also shows a relatively good flame-retardant effect when used alone, but together with compounds of the present invention it forms even much more effective combinations that have great potential as flame-retardant compositions.

In summary the above experiments clearly show that the novel DOPS derivatives are suitable as flame retardants with compact polymers, alone or in combination with a further synergistic additive, wherein the synergy has been identified herein as being substance-specific. This is especially the case when they are used in combination with elemental sulfur or sulfur-containing compounds with which they show a synergistic effect. Finding the respectively best suited synergist for a certain inventive compound will consequently be the objective of further examinations. An average artisan should easily be able to achieve that without undue experimentation, for example, by testing a panel of known flame-retardants in combination with each individual DOPS derivative in serial experiments according to UL94 and/or ISO 4589.

b) Effectiveness with Expandable Polymerizates or Polymeric Foams:

For the inventive flame-retardant, expandable, blowing agent-containing polymerizates as well as the polymeric foams producible therewith—which entail the above mentioned known special problems—the results are also unambiguous and confirm the various advantages of the above flame retardants.

### Results and Evaluation of the First Experimental Series:

The following Table 6 shows a clear comparison of the results of the above described first experimental series, wherein the parameters of viscosity decrease in the extruder, the time until the foamed beads collapse, as well as the fire behavior of the defined specimens are examined.

TABLE 6
First experimental series - examination of the expandable
polymerizates or the polymeric foams

| | | Viscosity | |
|---|---|---|---|
| | Fire | decrease | Time to |
| | test | in extruder | collapse |
| Experiment 1 (according to Example 1) | 3 | 2 | 2 |
| Experiment 2 (according to Example 2) | 2 | 2 | 2 |
| Experiment 3 (according to Example 3) | 1 | 2 | 2 |
| Experiment 4 (according to Example 4) | 4 | 4 | 4 |
| Experiment 5 (according to Example 5) | 1 | 2 | 2 |
| Experiment 6 (according to Example 6) | 2 | — | 2 |

The results of the experiments numbered 1 to 6 in the left column were obtained with products based on the above Examples 1 to 6.

Experiment 4 represents a reference point that corresponds to a polymerizate or foam with DOPO as the flame retardant. In Table 6, all results of this reference experiment 4 are shown with a value of 4 in each column, i.e. for each test. These results for DOPO are based on reference polymers that either contain HBCD as a flame retardant or no flame retardant at all. Small numbers, especially 1, are usually more advantageous, larger numbers, especially 5, more disadvantageous.

### Details:

### Fire Test (Column 1 in Table 6):

The granular EPS obtained in Examples 1 to 5 and the EPS beads from Example 6 were prefoamed with saturated steam to give foam beads having a bulk density of 15 to 25 kg/m³, which were stored for 24 hours, and then formed in an automatic press to give foam sheets.

From the foam sheets, specimens of a thickness of 2 cm were cut, conditioned for 72 hours at 70° C., and then subjected to a fire test according to DIN 4102-2 (B2-small burner test).

The results with values of 1 and 5 were evaluated in comparison to EPS with hexabromocyclododecane (HBCD) as the flame retardant (Sunpor® EPS SE). In column 1, values of 1 show that the performance of the test substance with regard to fire behavior is as good as that of EPS with HBCD as the flame retardant. Values of 5 show that the fire behavior is very poor and does not correspond to that of flameproof EPS.

Column 1 of Table 5 (Experiments 1 and 2) thus shows that polystyrene foam sheets foamed from EPS containing hydroxy DOPS as the flame retardant show much better flame retardancy than polystyrene without flame retardant, and also show much better flame retardancy than polystyrene containing DOPO as the flame retardant. Furthermore, the values come close to the good flame-retardant effect of polystyrene containing HBCD as the flame retardant, especially with higher DOPS concentrations of 10% according to Experiment 2.

Also, this result is independent of the production method of the granular EPS or EPS beads, as is shown in Experiment 6.

Further addition of flame retardant synergists or stabilizers may improve the result even more; one can achieve a fire-resistance that corresponds to that of HBCD-protected EPS, as shown in Experiment 5.

### Viscosity Decrease in the Extruder (Column 2 in Table 6):

During extrusion in Examples 1 to 5, the viscosity of the polymer melt decreased immediately after starting the dosing of the above phosphorus-based flame retardant, which was shown by a pressure decrease of the polymer melt in the area in front of the nozzle plate. GPC analyses showed that these were not caused by any degradation of polymer chains.

The results with values of 1 and 5 show the pressure decrease compared to the rising pressure within the polymer melt without flame retardant. In column 2, values of 1 mean that there is no difference or no pressure decrease. Values of 5 mean that there was a strong decrease in viscosity.

Consequently, Experiments 1 and 2 show that the above flame retardants, especially DOPS-OH, do not interfere with the polymer melt and that their viscosity decreases only slightly. In comparison, the results for DOPO were much poorer.

### Time to Collapse (Column 3 in Table 6):

The granular EPS obtained from Examples 1 to 5 and EPS beads obtained from Example 6 were prefoamed with saturated steam to give foam beads having a bulk density of 15 to 25 kg/m³, stored for 24 hours, and then formed in an automatic press to give foam sheets.

Due to the softening effect of the phosphorus-based flame retardants, the EPS particles showed different stabilities during prefoaming, expressed in terms of the time for which the foamed beads could be subjected to steam until they collapsed. This time was evaluated in the summary of results in comparison to EPS particles without flame retardant.

In column 3, values of 1 mean that the beads have normal stability. Values of 5 mean that the beads collapse immediately.

Consequently, Experiments 1 and 2 show that the above flame retardants, especially DOPS-OH, do not interfere with the stability of the foam beads. In comparison, the results for DOPO were much poorer.

In summary, in all three aspects tested, the inventive polymerizates and foams are more advantageous than polymerizates or foams protected with DOPO.

### Synergistic Effect of Sulfur:

As mentioned at the beginning, it was surprisingly found that the novel compounds in combination with elemental sulfur and other sulfur-containing compounds show synergistic effects as flame retardants in expandable polymerizates or foams.

Comparative experiments show that the novel compounds of the present invention show, when used in combination with elemental sulfur or sulfur-containing compounds, with which they have a synergistic effect, substantially better flame retardancy than the known DOPO additive. This is, for example, shown by a comparison of the above tables with Table 6, but also by the fact that doubling the amount of sulfur in Experiment No. 7 as compared to Experiment No. 6 does not result in any improvement of the fire-protective effect.

The following comparative experiments clearly show the strong effect of sulfur:

### Example 1

### Example of the Invention

To a styrene polymer (SUNPOR EPS-STD: 6 wt % of pentane, chain length Mw=200,000 g/mol, non-uniformity Mw/Mn=2.5) in the feed area of a twin-screw extruder, 5 wt % of 6-hydroxy-6H-dibenz[c,e][1,2]-oxaphosphorine-6-sulfide (hydroxy-DOPS) and 2 wt % of yellow sulfur (S₈), based on the granular EPS obtained, were added and molten in the extruder at 190° C. The polymer melt thus obtained was conveyed through a nozzle plate with a flow rate of 20 kg/h and granulated with a pressurized underwater granulator to give compact granular EPS.

### Example 2

### Example of the Invention

Example 1 was repeated, but with the difference that 10 wt % of 6-hydroxy-6H-dibenz[c,e][1,2]oxaphosphorine-6-sulfide (hydroxy-DOPS), based on the granular EPS obtained, were added.

### Example 3

### Comparative Example—DOPO

To a styrene polymer (SUNPOR EPS-STD: 6 wt % of pentane, chain length Mw=200,000 g/mol, non-uniformity Mw/Mn=2.5) in the feed area of a twin-screw extruder, 10 wt % of 9,10-dihydro-9-oxa-10-phospha-phenanthrene-10-oxide (DOPO) and 2 wt % of yellow sulfur (S₈), based on the granular EPS obtained, were added and molten in the extruder at 190° C. The polymer melt thus obtained was conveyed through a nozzle plate with a flow rate of 20 kg/h and granulated with a pressurized underwater granulator to give compact granular EPS.

### Example 4

### Example of the Invention—Sulfur Only

To a styrene polymer (SUNPOR EPS-STD: 6 wt % of pentane, chain length Mw=200,000 g/mol, non-uniformity Mw/Mn=2.5) in the feed area of a twin-screw extruder, 2 wt % of yellow sulfur (S₈), based on the granular EPS obtained, were added and molten in the extruder at 190° C. The polymer melt thus obtained was conveyed through a nozzle plate with a flow rate of 20 kg/h and granulated with a pressurized underwater granulator to give compact granular EPS.

TABLE 7
Examination of the expandable polymerizates or the
polymeric foams with sulfur

| | | Viscosity | |
|---|---|---|---|
| | Fire | decrease | Time to |
| | test | in the extruder | collapse |
| Experiment 1 (according to Example 1) | 2 | 2 | 2 |
| Experiment 2 (according to Example 2) | 1 | 2 | 2 |
| Experiment 3 (according to Example 3) | 3 | 4 | 4 |
| Experiment 4 (according to Example 4) | 5 | 1 | 1 |

Evaluation of the results was conducted as in Table 6 and clearly shows the synergistic effect of sulfur. Polymerizates and foams protected in this way are, at least with regard to their fire behavior, more advantageous than polymerizates protected only with DOPO derivatives, than polymerizates protected with DOPS derivatives, and than polymerizates treated with pure sulfur.

### Results and Evaluation of the Second Experimental Series:

The following Table 8 shows a clear comparison of the results of the above described second experimental series, wherein the fire behavior of defined specimens was examined.

TABLE 8
Second experimental series - examination of the expandable polymerizates
or polymeric foams

| | | | | | EN 11925 | DIN 4102 |
|---|---|---|---|---|---|---|
| Exp. No. | FR | wt %* | Synergist | wt %* | (Euroclass E) | (class B2) |
| 1 | DOPO | 10 | | | not passed | not passed |
| 2 | DOPO | 15 | | | passed | not passed |
| 3 | | | Sulfur | 5 | not passed | not passed |
| 4 | DOPS-SNH(Et)₃ | 10 | | | passed | not passed |
| 5 | DOPS-SNH(Et)₃ | 10 | Sulfur | 2 | passed | passed |
| 6 | DOPS-ONH(Et)₃ | 10 | | | passed | not passed |
| 7 | DOPS-ONH(Et)₃ | 10 | Sulfur | 2 | passed | passed |
| 8 | DOPS-OMel | 7.5 | Sulfur | 2 | passed | passed |
| 9 | DOPS-OMel | 7.5 | BBDS | 5 | passed | not passed |
| 10 | DOPS-OGua | 7.5 | Sulfur | 2 | passed | passed |
| 11 | DOPS-OGua | 7.5 | BBDS | 5 | passed | not passed |
| 12 | DOPS-S-DOPS | 7.5 | sulfur | 2 | passed | passed |
| 13 | DOPS-S-DOPS | 7.5 | DCDS | 5 | passed | not passed |
| 14 | DOPS-S-DOPS | 7.5 | BBDS | 5 | passed | passed |
| 15 | DOPS-S₂-DOPS | 10 | | | passed | passed |
| 16 | DOPS-S₂-DOPS | 7.5 | sulfur | 2 | passed | not passed |
| 17 | DOPS-S₄-DOPS | 10 | | | passed | not passed |
| 18 | DOPS-S₄-DOPS | 7.5 | sulfur | 2 | passed | not passed |
| 19 | DOPS-O-DOPS | 7.5 | sulfur | 2 | passed | passed |
| 20 | DOPS-O-DOPO | 7.5 | sulfur | 2 | passed | passed |

*based on polystyrene

The results of the experiments numbered 1 to 20 in the left column were obtained in experiments with products or specimens based on the comparative examples and examples of the invention described above.

Experiments 1, 2 and 3 are references corresponding to a polymerizate or foam protected with only the known DOPO flame retardant or only containing sulfur as synergist.

### Details:

### Fire Test According to EN 11925 (Column 6) and DIN 4102 (Column 7):

The granular EPS obtained in Examples 1 to 18 were prefoamed with saturated steam to give foam beads having a bulk density of 15 to 25 kg/m′, stored for 24 hours, and then formed in an automatic press to give foam sheets. From the foam sheets, specimens with a thickness of 2 cm were cut, and after 72 hours of conditioning at 70° C., subjected to the fire tests according to EN 11925 and DIN 4102. Those tests that achieved the European fire class E according to EN 11925 or fire class B2 according to DIN 4102, were marked with “passed”.

It may be seen that, with the systems tested, the fire class E according to EN 11925 was achieved more readily than fire class B2 according to DIN 4102.

The results of Experiments 4 to 20 show that all DOPS derivatives tested give better results or are active in lower amounts than the known DOPO flame retardant (Experiments 1 and 2).

With DOPS-SNH(Et)₃ (Experiment 4) and DOPS-ONH(Et)₃ (Experiment 6), the use of only ⅔ of the amount of DOPO (Experiment 2) is required to achieve fire class E according to EN 11925. By using 2 wt % of sulfur, fire class B2 according to DIN 4102 (Experiments 5 and 7) may be achieved with these DOPS derivatives. The synergistic effect of 2 wt % of sulfur is also shown with DOPS-OMel (Experiment 8), DOPS-OGua (Experiment 10), DOPS-S-DOPS (Experiment 12), DOPS-O-DOPS (Experiment 19), and DOPO-O-DOPO (Experiment 20). A lower synergistic effect with these derivatives was obtained with 5 wt % of BBDS (Experiments 9 and 11) and 5 wt % of DCDS (Experiment 13), while 5 wt % of BBDS in combination with 7.5 wt % of DOPS-S-DOPS (Experiment 14) were sufficient to achieve fire class B2.

DOPS-S₂-DOPS is a special case because it meets the requirements of fire classes B2 and E (Experiment 17) at a concentration of 10 wt %, while a combination of 7.5 wt % of DOPS-S₂-DOPS and 2 wt % of sulfur (Experiment 18) does mot meet the requirements of class B2.

The fire protection systems of Experiments 17 (10 wt % of DOPS-S₄-DOPS) and 18 (7.5 wt % of DOPS-S₄-DOPS+2 wt % of sulfur) meet the requirements of fire class E according to EN 11925, but not those of class B2 according to DIN 4102.

In summary, the inventive polymerizates and foams are more advantageous than polymerizates and foams provided with DOPO as flame retardant.

1. Flameproof expandable polymerizates containing at least one blowing agent, wherein at least one phosphorus compound is contained as a flame retardant, characterized in that the flame retardant is a 9,10-dihydro-9-oxa-10-phosphaphenanthrene derivative of formula I 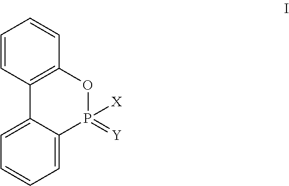
wherein X is hydrogen and Y is sulfur, i.e. 9,10-dihydro-9-oxa-10-phosphaphenanthrene-10-thione or -10-sulfide (“DOPS”): 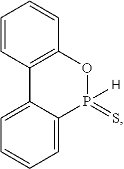
or a ring-opened hydrolyzate thereof.

2. Flameproof expandable polymerizates containing at least one blowing agent, wherein at least one phosphorus compound is contained as a flame retardant, characterized in that the flame retardant is a 9,10-dihydro-9-oxa-10-phosphaphenanthrene derivative of formula I, wherein X is OH and Y is sulfur, i.e. 9,10-dihydro-10-hydroxy-9-oxa-10-phosphaphenanthrene-10-thione or -10-sulfide (“DOPS-OH”): 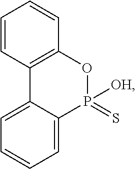
or a ring-opened hydrolyzate thereof.

3. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is ONH₄ and Y is sulfur, i.e. 9,10-dihydro-10-hydroxy-9-oxa-10-phosphaphenanthrene-10-thione or -10-sulfide ammonium salt (“DOPS-ONH₄”): 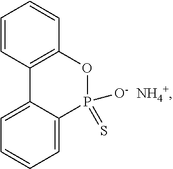
or a ring-opened hydrolyzate thereof.

4. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is SH and Y is sulfur, i.e. 9,10-dihydro-10-mercapto-9-oxa-10-phosphaphenanthrene-10-thione or 10-sulfid (“DOPS-SH”): 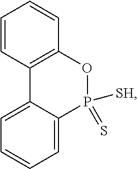
or a ring-opened hydrolyzate thereof.

5. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is SNH(Et)₃ and Y is sulfur, i.e. 9,10-dihydro-10-mercapto-9-oxa-10-phosphaphenanthrene-10-thione or -10-sulfide triethylammonium salt (“DOPS-SNH(Et)₃”): 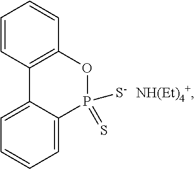
or a ring-opened hydrolyzate thereof.

6. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is ONH(Et)₃ and Y is sulfur, i.e. 9,10-dihydro-10-hydroxy-9-oxa-10-phosphaphenanthrene-10-thione or 10-sulfide triethylammonium salt (“DOPS-ONH(Et)₃”): 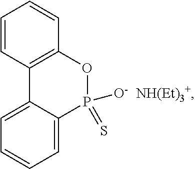
or a ring-opened hydrolyzate thereof.

7. Flameproof expandable polymerizates containing at least one blowing agent, wherein at least one phosphorus compound is contained as flame retardant, characterized in that the flame retardant is a 9,10-Dihydro-9-oxa-10-phosphaphenanthrene derivative of formula I, wherein X is OMel and Y is sulfur, i.e. 9,10-dihydro-10-hydroxy-9-oxa-10-phosphaphenanthrene-10-thione or -10-sulfide melaminium salt (“DOPS-OMel”): 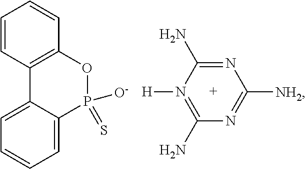
or a ring-opened hydrolyzate thereof.

8. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is OGua and Y is sulfur, i.e. 9,10-dihydro-10-hydroxy-9-oxa-10-phosphaphenanthrene-10-thione or -10-sulfide guanidinium salt (“DOPS-OGua”): 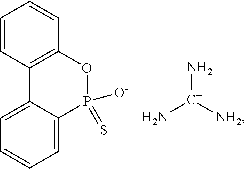
or a ring-opened hydrolyzate thereof.

9. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I 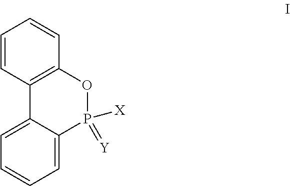
wherein X is a divalent linker group Zₙ linking two dihydrooxaphosphaphenanthrenyl residues of formula I to give a dimer of the following formula II 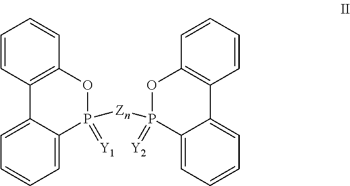
wherein Y₁ and Y₂ are each oxygen, Z is sulfur and n=1, i.e. bis(9,10-dihydro-9-oxa-10-oxo-10-phosphaphenanthrene-10-yl)sulfide (“DOPO-S-DOPO”): 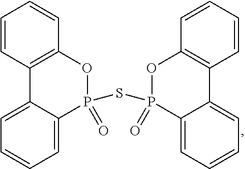
or a ring-opened hydrolyzate thereof.

10. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁ and Z are each sulfur, Y₂ is oxygen and n=1, i.e. 9,10-dihydro-10-(9,10-dihydro-9-oxa-10-phospha-10-thioxophenanthrene-10-ylthio)-9-oxa-10-phosphaphenanthrene-10-one or -10-oxide (“DOPS-S-DOPO”): 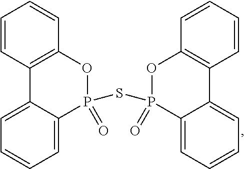
or a ring-opened hydrolyzate thereof.

11. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁, Y₂, and Z are each sulfur and n=1, i.e. bis(9,10-dihydro-9-oxa-10-phospha-10-thioxophenanthrene-10-yl)sulfide (“DOPS-S-DOPS”): 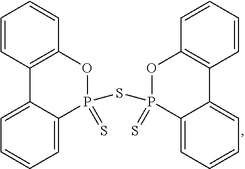
or a ring-opened hydrolyzate thereof.

12. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁, Y₂, and Z are each sulfur and n=2, i.e. bis(9,10-dihydro-9-oxa-10-phospha-10-thioxophenanthrene-10-yl)disulfide (“DOPS-S₂-DOPS”): 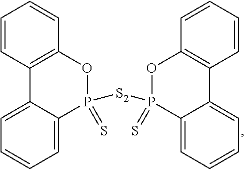
or a ring-opened hydrolyzate thereof.

13. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁, Y₂, and Z are each sulfur and n=4, i.e. bis(9,10-dihydro-9-oxa-10-phospha-10-thioxophenanthrene-10-yl)tetrasulfide (“DOPS-S₄-DOPS”): 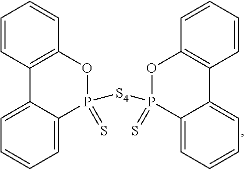
or a ring-opened hydrolyzate thereof.

14. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁ and Y₂ are each sulfur, Z is oxygen and n=1, i.e. di(9,10-dihydro-9-oxa-10-phospha-10-thioxophenanthrene-10-yl)ether (“DOPS-O-DOPS”): 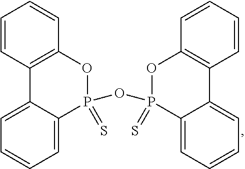
or a ring-opened hydrolyzate thereof.

15. Flameproof expandable polymerizates containing at least one blowing agent, wherein at least one phosphorus compound is contained as flame retardant, characterized in that the flame retardant is a 9,10-dihydro-9-oxa-10-phosphaphenanthrene derivative of formula I, wherein X is a divalent linker group Zₙ linking two dihydrooxaphosphaphenanthrenyl residues to give a dimer of formula II, wherein Y₁ is sulfur, Y₂ and Z are each oxygen and n=1, i.e. 9,10-dihydro-10-(9,10-dihydro-9-oxa-10-phospha-10-thioxophenanthrene-10-yloxy)-9-oxa-10-phosphaphenanthrene-10-one or -10-oxide (“DOPS-O-DOPO”): 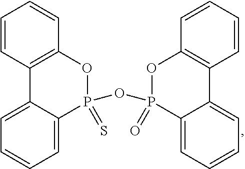
or a ring-opened hydrolyzate thereof.

16. Expandable polymerizates according to claim 1 characterized in that the expandable polymerizates are expandable styrene polymerizates (EPS) or expandable granular styrene polymers (EPS), especially consisting of homo- and copolymers of styrene, preferably crystal-clear polystyrene (GPPS), high-impact polystyrene (HIPS), anionically polymerized polystyrene or impact-resistant polystyrene (A-IPS), copolymers of styrene and alpha-methylstyrene, acrylonitrile-butadiene-styrene polymerizates (ABS), styrene-acrylonitrile (SAN), acrylonitrile-styrene-acrylic ester (ASA), methylacrylate-butadien-styrene (MBS), methylmethacrylate-acrylonitrile-butadiene-styrene (MABS) polymerizates or mixtures thereof or mixtures with polyphenylene ether (PPE).

17. Expandable polymerizates according to claim 1 characterized in that the flame retardant(s) is/are contained in an amount of 0.1 to 25 wt %, especially 3 to 10 wt %, based on the total weight of the polymer.

18. Expandable polymerizates according to claim 1 characterized in that additionally elemental sulfur, especially yellow sulfur (S₈), and/or at least one further inorganic or organic sulfur-containing compound or sulfur compound is/are contained, especially in an amount of 0.1 to 10 wt %, especially 0.5 to 5 wt %, preferably approximately 2 wt %, based on the total weight of the polymer.

19. Expandable polymerizates according to claim 18 characterized in that the further sulfur-containing compound or sulfur compound comprises at least one S—S bond, wherein at least one of the sulfur atoms is divalent.

20. A method for preparing the flameproof expandable polymerizates according to claim 1 characterized in that at least one phosphorus compound or ring-opened hydrolyzate or salt thereof are used as (a) flame retardant(s), and optionally sulfur and/or at least one sulfur-containing compound are used as additional flame retardant or synergist.

21. The method for preparing flameproof expandable styrene polymerizates (EPS) according to claim 20,
wherein the flame retardant and a blowing agent and optionally sulfur or the sulfur compound are mixed with a styrene polymer melt using a dynamic or static mixer and subsequently granulated,
or
wherein the flame retardant and optionally sulfur or the sulfur compound are mixed into the still granular polystyrene polymerizate using a dynamic or static mixer, and melted, whereafter the melt is impregnated and granulated,
or
wherein the flame retardant and optionally sulfur or the sulfur compound are mixed into the still granular polystyrene polymerizate using a dynamic or static mixer, whereafter the melt is molten and granulated,
or
wherein granulation is achieved by suspension polymerization of styrene in an aqueous suspension in the presence of the flame retardant and a blowing agent and optionally of sulfur or the sulfur compound.

22. The method for preparing flameproof expandable styrene polymerizates (EPS) according to claim 20, comprising the steps of:
jointly dosing granular PS or EPS having a molecular weight of Mw >120,000 g/mol, preferably 150,000 to 250,000 g/mol, especially preferably 180,000 to 220,000 g/mol, and the at least one flame retardant and optionally one or more further additives, especially
a) flame retardancy synergists, e.g. thermal radical formers such as dicumyl peroxide, in a concentration of 0.1 to 20 wt %,
b) infrared opacifiers, e.g. graphite, carbon black, aluminum, titanium dioxide, in a concentration of 0.1 to 1 wt %,
c) stabilizers, e.g. nitroxyl radical-forming substances such as HTEMPO, in a concentration of 0.1 to 1 wt %,
d) further halogenated or halogen-free flame retardants, e.g. HBCD, DOPO, magnesium hydroxide, in an concentration of 0.1 to 20 wt %, and/or
e) fillers, e.g. chalk, talcum, silicates, in a concentration of 1 to 20 wt %, into an extruder,
jointly melting of all components in the extruder,
optionally adding at least one blowing agent,
mixing all components at a temperature >120° C.,
granulation by means of pressurized underwater granulation, at e.g. 1-20 bar, to a granule size <5 mm, preferably 0.2 to 2.5 mm, at a water temperature of 30 to 100° C., especially 50 to 80° C.,
optionally coating the surface with coating agents, e.g. silicates, metal salts of fatty acids, fatty acid esters, fatty acid amides.

23. Flameproof expandable styrene polymerizates (EPS) obtainable by the method according to claim 20.

24. Polymeric foams, especially styrene polymeric particle foam or extruded polystyrene rigid foam (XPS), containing at least one phosphorus compound according to claim 1 or a ring-opened hydrolyzate or salt thereof as (a) flame retardant(s).

25. The polymeric foam according to claim 24 characterized in that sulfur and/or at least one sulfur-containing compound or sulfur compound is contained as a further flame retardant or as a synergist.

26. The polymeric foam according to claim 25, obtainable from flameproof expandable polymerizates, especially from expandable styrene polymerizates (EPS), especially by foaming and caking the polymerizates or by extrusion.

27. The polymeric foam according to claim 24 having a density between 7 and 200 g/L and a mainly closed-cell structure with more than 0.5 cells per mm³.

28. A use of at least one phosphorus compound according to claim 1 or of a ring-opened hydrolyzate or salt thereof as (a) flame retardant(s) and optionally of sulfur and/or at least one sulfur-containing compound or sulfur compound as (a) flame retardant(s) or as (a) synergist(s)
in expandable polymerizates, especially in expandable styrene polymerizates (EPS) or expandable granular styrene polymers (EPS),
or
in polymeric foams, especially in styrene polymeric particle foams, obtainable by foaming from expandable polymerizates, or in extruded polystyrene rigid foams (XPS).
